(19) United States
(12) Patent Application Publication
(10) Pub. No.: US 2023/0189388 A1
(43) Pub. Date: Jun. 15, 2023

(54) Communication Method and Apparatus

(71) Applicant: Huawei Technologies Co., Ltd., Shenzhen (CN)

(72) Inventors: Chang Yu, Shenzhen (CN); Junren Chang, Beijing (CN); Guowei Ouyang, Beijing (CN)

(21) Appl. No.: 18/050,805

(22) Filed: Oct. 28, 2022

Related U.S. Application Data
(63) Continuation of application No. PCT/CN2021/091634, filed on Apr. 30, 2021.

(30) Foreign Application Priority Data
Apr. 30, 2020 (CN) 202010367323.X

(51) Int. Cl. H04W 76/28; H04W 52/02

(52) U.S. Cl. CPC H04W 76/28; H04W 52/0274

(57) ABSTRACT

This application provides a communication method and apparatus. The communication method and apparatus may be applied to an Internet of Vehicles system, a V2X system, and a device-to-device communication system. The method includes: obtaining first indication information and second indication information, where the first indication information indicates a first periodicity for receiving signaling and/or data and a second periodicity for not receiving signaling and data, and the second indication information indicates a first time unit for receiving signaling and/or data and a second time unit for not receiving signaling and data in the first periodicity; and determining to receive signaling and/or data in the first time unit.

### CROSS-REFERENCE TO RELATED APPLICATIONS

This application is a national stage of International Application No. PCT/CN2021/091634, filed on Apr. 30, 2021, which claims priority to Chinese Patent Application No. 202010367323.X, filed on Apr. 30, 2020, both of which are incorporated herein by reference their entireties.

### TECHNICAL FIELD

This application relates to the communication field, and in particular, to a communication method and apparatus.

### BACKGROUND

Currently, a terminal device may implement discontinuous transmission (discontinuous transmission, DTX) and/or discontinuous reception (discontinuous reception, DRX) based on a wakeup/sleep configuration, to reduce power consumption.

However, different terminal devices may have different wakeup/sleep configurations. On one hand, if the terminal device performs monitoring only based on a wakeup/sleep configuration of the terminal device, a burst service may be missed by a terminal device with a different wakeup/sleep configuration. This results in a low monitoring success rate and poor communication reliability. On the other hand, if the terminal device monitors a burst service based on a union set of wakeup time periods corresponding to a plurality of wakeup/sleep configurations, or keeps being in a wakeup state, power consumption of the terminal device remains high.

### SUMMARY

Embodiments of this application provide a communication method and apparatus, to resolve difficulty in balancing power consumption of a terminal device and SL communication reliability, and to improve data transmission efficiency.

To achieve the foregoing objectives, the following technical solutions are used in this application.

According to a first aspect, a communication method is provided. The method includes: obtaining first indication information and second indication information, where the first indication information indicates a first periodicity for receiving signaling and/or data and a second periodicity for not receiving signaling and data, and the second indication information indicates a first time unit for receiving signaling and/or data and a second time unit for not receiving signaling and data in the first periodicity; and determining to receive signaling and/or data in the first time unit.

Based on the communication method in the first aspect, a terminal device determines the first periodicity and the second periodicity based on the first indication information, and determines the first time unit and the second time unit in the first periodicity based on the second indication information. In this way, the terminal device may monitor signaling and/or data only in the first time unit in the first periodicity, that is, enter a wakeup state, and enter a sleep state in the second periodicity and the second time unit in the first periodicity. This implements discontinuous transmission and/or discontinuous reception of the terminal device, and reduces power consumption of the terminal device.

In a possible design solution, the first indication information may include L1 indication fields. The L1 indication fields correspond to L1 periodicities, and the L1 periodicities include the first periodicity and the second periodicity.

Similarly, the second indication information may include L2 indication fields. The L2 indication fields correspond to L2 time units included in the first periodicity, and the L2 time units include the first time unit and the second time unit.

Alternatively,

In a possible design solution, the first indication information may include L1 indication fields, and the L1 indication fields correspond to L1 continuous periodicities, indicating that the terminal device needs to monitor data/signaling or skip monitoring data/signaling in a periodicity corresponding to each indication field; or indicating that the terminal device may send data/signaling or skip sending data/signaling in a periodicity corresponding to each indication field.

Similarly, the second indication information may include L2 indication fields, and the L2 indication fields correspond to L2 continuous time units included in the first periodicity, and indicate that the terminal device needs to monitor data/signaling or skip monitoring data/signaling in a time unit corresponding to each indication field; or indicating that the terminal device may send data/signaling or skip sending data/signaling in a periodicity corresponding to each indication field.

Optionally, the first indication information and the second indication information may be implemented in a two-level bit mapping (bitmap) manner. For example, the L1 indication fields may be L1 bits (bit), and indicate the first periodicity and the second periodicity in the L1 continuous periodicities. The L2 indication fields may be L2 bits, and indicate the first time unit and the second time unit in the first periodicity.

In this embodiment of this application, a time length of the first periodicity may be greater than or equal to a time length of the L2 continuous time units. When the time length of the first periodicity is greater than the time length of the L2 continuous time units, it may be considered that there is a time interval (GAP) between two groups of time units included in two adjacent periodicities. In other words, the two groups of time units are discontinuous in this case. When the time length of the first periodicity is equal to the time length of the L2 continuous time units, it may be considered that there is no time interval between two groups of time units included in two adjacent periodicities. In other words, the two groups of time units are continuous in this case.

In this embodiment of this application, the periodicity, for example, the first periodicity and the second periodicity, may include a plurality of continuous or discontinuous time units. The time unit included in the first periodicity may be one or more of the following: a system frame (system frame), a direct frame (direct frame), a subframe (subframe), a slot (slot), a short slot (short-slot or mini-slot), and a symbol (symbol).

Optionally, the signaling may be for sidelink (sidelink, SL) communication.

Optionally, the first indication information and the second indication information are associated with a resource pool, and/or associated with a terminal device, a cell, and a resource allocation mode. For example, the resource pool includes the first periodicity and the second periodicity in time domain. In this way, the terminal device may monitor signaling and/or data on a resource in the resource pool associated with the first time unit, to implement a communication function.

According to a second aspect, a communication method is provided. The method includes: obtaining first indication information and second indication information, where the first indication information indicates a first periodicity for sending signaling and/or data and a second periodicity for not sending signaling and data, and the second indication information indicates a first time unit for sending signaling and/or data and a second time unit for not sending signaling and data in the first periodicity; and determining to send signaling and/or data in the first time unit.

In a possible design solution, the first indication information may include L1 indication fields. The L1 indication fields correspond to L1 periodicities, and the L1 periodicities include the first periodicity and the second periodicity.

Similarly, the second indication information may include L2 indication fields, the L2 indication fields correspond to L2 time units included in the first periodicity, and the L2 time units include the first time unit and the second time unit.

Alternatively,

In a possible design solution, the first indication information may include L1 indication fields, and the L1 indication fields correspond to L1 continuous periodicities, indicating that the terminal device needs to monitor data/signaling or skip monitoring data/signaling in a periodicity corresponding to each indication field; or indicating that the terminal device may send data/signaling or skip sending data/signaling in a periodicity corresponding to each indication field.

Similarly, the second indication information may include L2 indication fields, and the L2 indication fields correspond to L2 continuous time units included in the first periodicity, and indicate that the terminal device needs to monitor data/signaling or skip monitoring data/signaling in a time unit corresponding to each indication field; or indicating that the terminal device may send data/signaling or skip sending data/signaling in a periodicity corresponding to each indication field.

Optionally, the first indication information and the second indication information may be implemented in a two-level bit mapping manner. For example, the L1 indication fields may be L1 bits, indicating time-domain locations of the first periodicity and the second periodicity in the L1 continuous periodicities. The L2 indication fields may be L2 bits, indicating the first time unit and the second time unit in the first periodicity.

In this embodiment of this application, a time length of the first periodicity may be greater than or equal to a time length of the L2 continuous time units. When the time length of the first periodicity is greater than the time length of the L2 continuous time units, it may be considered that there is a gap between two groups of time units included in two adjacent periodicities. In other words, the two groups of time units are discontinuous in this case. When the time length of the first periodicity is equal to the time length of the L2 continuous time units, it may be considered that there is no time interval between two groups of time units included in two adjacent periodicities. In other words, the two groups of time units are continuous in this case.

In this embodiment of this application, the periodicity, for example, the first periodicity and the second periodicity, may include a plurality of continuous time units. For example, the time unit included in the first periodicity may be one or more of the following: a system frame, a direct frame, a subframe, a slot, a short slot, and a symbol.

Optionally, the signaling may be for SL communication.

Optionally, the first indication information and the second indication information are associated with a resource pool, and/or associated with a terminal device, a cell, and a resource allocation mode. For example, the resource pool includes the first periodicity and the second periodicity in time domain. In this way, the terminal device may send signaling and/or data on a resource in the resource pool associated with the first time unit, to implement a communication function.

In addition, for technical effect of the communication method in the second aspect, refer to the technical effect of the communication method in the first aspect. Details are not described herein again.

According to a third aspect, a communication method is provided. The method includes: determining that a first configuration matches or mismatches a first DRX configuration; and determining, based on a matching result, a second DRX configuration that matches the first configuration, where the second DRX configuration is for receiving signaling and/or data.

Based on the communication method in the third aspect, a terminal device determines whether the first configuration matches the first DRX configuration. If the first configuration matches the first DRX configuration, the terminal device sends/receives signaling and/or data based on the first DRX configuration. If the first configuration mismatches the first DRX configuration, the second DRX configuration that matches the first DRX configuration is generated, and the terminal device sends/receives signaling and/or data based on the second DRX configuration. For example, the terminal device sends/receives signaling and/or data in a wakeup time period corresponding to the second DRX configuration, and sleeps in a sleep time period corresponding to the second DRX configuration. In this way, high power consumption caused when the terminal device keeps awake to avoid missing a burst service can be resolved, and low monitoring success rate caused by a difference between a DRX configuration of a terminal device and a DTX configuration of another terminal device can be resolved. This meets requirements of both low power consumption and communication reliability of the terminal device.

In a possible design solution, the determining, based on a matching result, a second DRX configuration that matches the first configuration may include: determining the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration.

In another possible design solution, the determining, based on a matching result, a second DRX configuration that matches the first configuration may include: determining the second DRX configuration based on the first DRX configuration and/or the first configuration if the first configuration mismatches the first DRX configuration.

Optionally, the solution according to the third aspect may further include: receiving signaling and/or data based on the first DRX configuration.

Optionally, the solution according to the third aspect may further include: receiving a first switching indication based on the first DRX configuration. The first switching indication indicates switching from receiving signaling and/or data based on the first DRX configuration to receiving signaling and/or data based on the second DRX configuration.

The solution according to the third aspect may further include: receiving a second switching indication based on the second DRX configuration. The second switching indication indicates switching from receiving signaling and/or data based on the second DRX configuration back to receiving signaling and/or data based on the first DRX configuration.

In a possible design solution, the first configuration corresponds to one or more time-domain adjustment amounts. Correspondingly, the determining the second DRX configuration based on the first DRX configuration and/or the first configuration may include: determining the second DRX configuration by adjusting a time-domain location of a wakeup time period corresponding to the first DRX configuration and/or the first configuration based on the one or more time-domain adjustment amounts.

Optionally, a start location and/or an end location of a wakeup time period corresponding to the second DRX configuration are/is within the wakeup time period corresponding to the first configuration.

Optionally, the first DRX configuration may be a broadcast-dedicated DRX configuration with a smallest DRX cycle among a plurality of preconfigured or predefined broadcast-dedicated DRX configurations.

Further, the first DRX configuration is for receiving signaling and/or data that is originally configured to be received based on a plurality of broadcast-dedicated DRX configurations.

In a possible design solution, the first configuration may include a service configuration and/or a resource pool configuration.

According to a fourth aspect, a communication method is provided. The method includes: determining that a first configuration matches or mismatches a first DRX configuration; and determining, based on a matching result, a second DRX configuration that matches the first configuration, where the second DRX configuration is for sending signaling and/or data.

In a possible design solution, the determining, based on a matching result, a second DRX configuration that matches the first configuration may include: determining the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration.

In another possible design solution, the determining, based on a matching result, a second DRX configuration that matches the first configuration may include: determining the second DRX configuration based on the first DRX configuration and/or the first configuration if the first configuration mismatches the first DRX configuration.

Optionally, the solution according to the fourth aspect may further include: sending signaling and/or data and/or selecting a resource based on the first DRX configuration.

Optionally, the solution according to the fourth aspect may further include: sending a first switching indication based on the first DRX configuration. The first switching indication indicates switching from sending signaling and/or data based on the first DRX configuration to sending signaling and/or data based on the second DRX configuration.

The solution according to the fourth aspect may further include: sending a second switching indication based on the second DRX configuration. The second switching indication indicates switching from sending signaling and/or data based on the second DRX configuration back to sending signaling and/or data based on the first DRX configuration.

In a possible design solution, the first configuration corresponds to one or more time-domain adjustment amounts. Correspondingly, the determining the second DRX configuration based on the first DRX configuration and/or the first configuration may include: determining the second DRX configuration by adjusting a time-domain location of a wakeup time period corresponding to the first DRX configuration and/or the first configuration based on the one or more time-domain adjustment amounts.

Optionally, a start location and/or an end location of a wakeup time period corresponding to the second DRX configuration are/is within the wakeup time period corresponding to the first configuration.

Optionally, the first DRX configuration is a broadcast-dedicated DRX configuration with a smallest DRX cycle among a plurality of preconfigured or predefined broadcast-dedicated DRX configurations.

Further, the first DRX configuration is for receiving signaling and/or data that is originally configured to be received based on a plurality of broadcast-dedicated DRX configurations.

In a possible design solution, the first configuration may include a service configuration and/or a resource pool configuration.

In addition, for technical effect of the communication method in the fourth aspect, refer to the technical effect of the communication method in the third aspect. Details are not described herein again.

According to a fifth aspect, a communication apparatus is provided. The apparatus includes an obtaining module and a determining module. The obtaining module is configured to obtain first indication information and second indication information. The first indication information indicates a first periodicity for receiving signaling and/or data and a second periodicity for not receiving signaling and data, and the second indication information indicates a first time unit for receiving signaling and/or data and a second time unit for not receiving signaling and data in the first periodicity. The determining module is configured to determine to receive signaling and/or data in the first time unit.

In a possible design solution, the first indication information may include L1 indication fields. The L1 indication fields correspond to L1 periodicities, and the L1 periodicities include the first periodicity and the second periodicity.

Similarly, the second indication information may include L2 indication fields. The L2 indication fields correspond to L2 time units included in the first periodicity, and the L2 time units include the first time unit and the second time unit.

Alternatively,

In a possible design solution, the first indication information may include L1 indication fields, and the L1 indication fields correspond to L1 continuous periodicities, indicating that the terminal device needs to monitor data/signaling or skip monitoring data/signaling in a periodicity corresponding to each indication field; or indicating that the terminal device may send data/signaling or skip sending data/signaling in a periodicity corresponding to each indication field.

Similarly, the second indication information may include L2 indication fields, and the L2 indication fields correspond to L2 continuous time units included in the first periodicity, and indicate that the terminal device needs to monitor data/signaling or skip monitoring data/signaling in a time unit corresponding to each indication field; or indicating that the terminal device may send data/signaling or skip sending data/signaling in a periodicity corresponding to each indication field.

Optionally, the first indication information and the second indication information may be implemented in a two-level bit mapping (bitmap) manner.

In this embodiment of this application, a time length of the first periodicity may be greater than or equal to a time length of the L2 continuous time units.

In this embodiment of this application, the periodicity, for example, the first periodicity and the second periodicity, may include a plurality of continuous time units. The time unit included in the first periodicity may be one or more of the following: a system frame (system frame), a direct frame (direct frame), a subframe (subframe), a slot (slot), a short slot (short-slot or mini-slot), and a symbol (symbol).

Optionally, the signaling may be for sidelink (sidelink, SL) communication.

Optionally, the first indication information and the second indication information are associated with a resource pool, and the resource pool includes the first periodicity and the second periodicity in time domain. In this way, the terminal device may monitor signaling and/or data on a resource in the resource pool associated with the first time unit, to implement a communication function.

Optionally, the communication apparatus in the fifth aspect may further include a transceiver module. The transceiver module is configured to implement a sending/receiving function of the communication apparatus in the fifth aspect, for example, to send signaling and/or data to another communication apparatus, or receive signaling and/or data sent by another communication apparatus. Optionally, the transceiver module may be a transceiver or an input/output port.

Optionally, modules having a processing function, such as the obtaining module and the determining module in the fifth aspect, may also be integrated into one module, for example, a processing module. The processing module may be a processor or another component having a processing function.

Optionally, the communication apparatus in the fifth aspect may further include a storage module, and the storage module stores a program or instructions. When the processing module executes the program or the instructions, the communication apparatus in the fifth aspect is enabled to perform the communication method in the first aspect.

It should be noted that the communication apparatus in the fifth aspect may be a terminal device, or may be a chip (system) or another part or component that can be disposed in the terminal device. This is not limited in this application.

In addition, for technical effect of the communication apparatus in the fifth aspect, refer to the technical effect of the communication method in the first aspect. Details are not described herein again.

According to a sixth aspect, a communication apparatus is provided. The apparatus includes an obtaining module and a determining module. The obtaining module is configured to obtain first indication information and second indication information. The first indication information indicates a first periodicity for sending signaling and/or data and a second periodicity for not sending signaling and data, and the second indication information indicates a first time unit for sending signaling and/or data and a second time unit for not sending signaling and data in the first periodicity. The determining module is configured to determine to send signaling and/or data in the first time unit.

In a possible design solution, the first indication information may include L1 indication fields. The L1 indication fields correspond to L1 periodicities, and the L1 periodicities include the first periodicity and the second periodicity.

Similarly, the second indication information may include L2 indication fields. The L2 indication fields correspond to L2 time units included in the first periodicity, and the L2 time units include the first time unit and the second time unit.

Alternatively,

In a possible design solution, the first indication information may include L1 indication fields, and the L1 indication fields correspond to L1 continuous periodicities, indicating that the terminal device needs to monitor data/signaling or skip monitoring data/signaling in a periodicity corresponding to each indication field; or indicating that the terminal device may send data/signaling or skip sending data/signaling in a periodicity corresponding to each indication field.

Similarly, the second indication information may include L2 indication fields, and the L2 indication fields correspond to L2 continuous time units included in the first periodicity, and indicate that the terminal device needs to monitor data/signaling or skip monitoring data/signaling in a time unit corresponding to each indication field; or indicating that the terminal device may send data/signaling or skip sending data/signaling in a periodicity corresponding to each indication field.

Optionally, the first indication information and the second indication information may be implemented in a two-level bit mapping (bitmap) manner.

In this embodiment of this application, a time length of the first periodicity may be greater than or equal to a time length of the L2 continuous time units.

In this embodiment of this application, the periodicity, for example, the first periodicity and the second periodicity, may include a plurality of continuous time units. The time unit included in the first periodicity may be one or more of the following: a system frame (system frame), a direct frame (direct frame), a subframe (subframe), a slot (slot), a short slot (short-slot or mini-slot), and a symbol (symbol).

Optionally, the signaling may be for sidelink (sidelink, SL) communication.

Optionally, the first indication information and the second indication information are associated with a resource pool, and the resource pool includes the first periodicity and the second periodicity in time domain. In this way, the terminal device may monitor signaling and/or data on a resource in the resource pool associated with the first time unit, to implement a communication function.

Optionally, the communication apparatus in the sixth aspect may further include a transceiver module. The transceiver module is configured to implement a sending/receiving function of the communication apparatus in the sixth aspect, for example, to send signaling and/or data to another communication apparatus, or receive signaling and/or data sent by another communication apparatus. Optionally, the transceiver module may be a transceiver or an input/output port.

Optionally, modules having a processing function, such as the obtaining module and the determining module in the sixth aspect, may also be integrated into one module, for example, a processing module. The processing module may be a processor or another component having a processing function.

Optionally, the communication apparatus in the sixth aspect may further include a storage module, and the storage module stores a program or instructions. When the processing module executes the program or the instructions, the communication apparatus in the aspect is enabled to perform the communication method in the second aspect.

It should be noted that the communication apparatus in the sixth aspect may be a terminal device, or may be a chip (system) or another part or component that can be disposed in the terminal device. This is not limited in this application.

In addition, for technical effect of the communication apparatus in the sixth aspect, refer to the technical effect of the communication method in the first aspect. Details are not described herein again.

According to a seventh aspect, a communication apparatus is provided. The apparatus includes a judging module and a determining module. The judging module is configured to determine whether a first configuration matches or mismatches a first DRX configuration. The determining module is configured to determine, based on a matching result, a second DRX configuration that matches the first configuration, where the second DRX configuration is for receiving signaling and/or data.

In a possible design solution, the determining module is specifically configured to determine the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration.

In another possible design solution, the determining module is specifically configured to determine the second DRX configuration based on the first DRX configuration and/or the first configuration if the first configuration mismatches the first DRX configuration.

Optionally, the communication apparatus in the seventh aspect may further include a transceiver module. The transceiver module is configured to receive signaling and/or data based on the first DRX configuration.

Optionally, the communication apparatus in the seventh aspect may further include a transceiver module. The transceiver module is configured to receive a first switching indication based on the first DRX configuration. The first switching indication indicates switching from receiving signaling and/or data based on the first DRX configuration to receiving signaling and/or data based on the second DRX configuration.

The transceiver module is further configured to receive a second switching indication based on the second DRX configuration. The second switching indication indicates switching from receiving signaling and/or data based on the second DRX configuration back to receiving signaling and/or data based on the first DRX configuration.

In a possible design solution, the first configuration corresponds to one or more time-domain adjustment amounts. The determining module is further configured to determine the second DRX configuration by adjusting a time-domain location of a wakeup time period corresponding to the first DRX configuration and/or the first configuration based on the one or more time-domain adjustment amounts.

Optionally, a start location and/or an end location of a wakeup time period corresponding to the second DRX configuration are/is within the wakeup time period corresponding to the first configuration.

Optionally, the first DRX configuration may be a broadcast-dedicated DRX configuration with a smallest DRX cycle among a plurality of preconfigured or predefined broadcast-dedicated DRX configurations.

Further, the first DRX configuration is for receiving signaling and/or data that is originally configured to be received based on a plurality of broadcast-dedicated DRX configurations.

In a possible design solution, the first configuration may include a service configuration and/or a resource pool configuration.

Optionally, the communication apparatus in the seventh aspect may further include a transceiver module. The transceiver module is configured to implement a sending/receiving function of the communication apparatus in the seventh aspect, for example, to send signaling and/or data to another communication apparatus, or receive signaling and/or data sent by another communication apparatus. Optionally, the transceiver module may be a transceiver or an input/output port.

Optionally, modules having a processing function, such as the judging module and the determining module in the seventh aspect, may also be integrated into one module, for example, a processing module. The processing module may be a processor or another component having a processing function.

Optionally, the communication apparatus in the seventh aspect may further include a storage module. The storage module stores a program or instructions. When the processing module executes the program or the instructions, the communication apparatus in the seventh aspect is enabled to perform the communication method in the third aspect.

It should be noted that the communication apparatus in the seventh aspect may be a terminal device, or may be a chip (system) or another part or component that can be disposed in the terminal device. This is not limited in this application.

In addition, for technical effect of the communication apparatus in the seventh aspect, refer to the technical effect of the communication method in the third aspect. Details are not described herein again.

According to an eighth aspect, a communication apparatus is provided. The apparatus includes a judging module and a determining module. The judging module is configured to determine whether a first configuration matches or mismatches a first DRX configuration. The determining module is configured to determine, based on a matching result, a second DRX configuration that matches the first configuration, where the second DRX configuration is for sending signaling and/or data.

In a possible design solution, the determining module is specifically configured to determine the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration.

In another possible design solution, the determining module is specifically configured to determine the second DRX configuration based on the first DRX configuration and/or the first configuration if the first configuration mismatches the first DRX configuration.

Optionally, the communication apparatus in the eighth aspect may further include a transceiver module. The transceiver module is configured to send signaling and/or data based on the first DRX configuration. The determining module is further configured to select a resource based on the first DRX configuration.

Optionally, the communication apparatus in the eighth aspect may further include a transceiver module. The transceiver module is configured to send a first switching indication based on the first DRX configuration. The first switching indication indicates switching from sending signaling and/or data based on the first DRX configuration to sending signaling and/or data based on the second DRX configuration.

The transceiver module is further configured to send a second switching indication based on the second DRX configuration. The second switching indication indicates switching from sending signaling and/or data based on the second DRX configuration back to sending signaling and/or data based on the first DRX configuration.

In a possible design solution, the first configuration corresponds to one or more time-domain adjustment amounts. The determining module is further configured to determine the second DRX configuration by adjusting a time-domain location of a wakeup time period corresponding to the first DRX configuration and/or the first configuration based on the one or more time-domain adjustment amounts.

Optionally, a start location and/or an end location of a wakeup time period corresponding to the second DRX configuration are/is within the wakeup time period corresponding to the first configuration.

Optionally, the first DRX configuration may be a broadcast-dedicated DRX configuration with a smallest DRX cycle among a plurality of preconfigured or predefined broadcast-dedicated DRX configurations.

Further, the first DRX configuration is for sending signaling and/or data that may be originally sent based on a plurality of broadcast-dedicated DRX configurations.

In a possible design solution, the first configuration may include a service configuration and/or a resource pool configuration.

Optionally, the communication apparatus in the eighth aspect may further include a transceiver module. The transceiver module is configured to implement a sending/receiving function of the communication apparatus in the eighth aspect, for example, to send signaling and/or data to another communication apparatus, or receive signaling and/or data sent by another communication apparatus. Optionally, the transceiver module may be a transceiver or an input/output port.

Optionally, modules having a processing function, such as the judging module and the determining module in the eighth aspect, may also be integrated into one module, for example, a processing module. The processing module may be a processor or another component having a processing function.

Optionally, the communication apparatus in the eighth aspect may further include a storage module. The storage module stores a program or instructions. When the processing module executes the program or the instructions, the communication apparatus in the eighth aspect can perform the communication method in the fourth aspect.

It should be noted that the communication apparatus in the eighth aspect may be a terminal device, or may be a chip (system) or another part or component that can be disposed in the terminal device. This is not limited in this application.

In addition, for technical effect of the communication apparatus in the eighth aspect, refer to the technical effect of the communication method in the third aspect. Details are not described herein again.

According to a ninth aspect, a communication apparatus is provided. The communication apparatus includes a processor. The processor is coupled to a memory. The memory is configured to store a computer program. The processor is configured to execute the computer program stored in the memory, to enable the communication apparatus to perform the communication method according to any possible implementation of the first aspect to the fourth aspect.

In a possible design, the communication apparatus in the ninth aspect may further include a transceiver. The transceiver may be a transceiver circuit or an input/output port. The transceiver may be used by the communication apparatus to communicate with another communication apparatus.

In this application, the communication apparatus in the ninth aspect may be a terminal device, or a chip or a chip system that can be disposed in the terminal device.

In addition, for technical effect of the communication apparatus in the ninth aspect, refer to the technical effect of the communication method according to any implementation of the first aspect to the fourth aspect. Details are not described herein again.

According to a tenth aspect, a communication system is provided. The system includes one or more terminal devices and one or more network devices.

According to an eleventh aspect, a computer-readable storage medium is provided. The computer-readable storage medium includes a computer program or instructions. When the computer program or the instructions are run on a computer, the computer is enabled to perform the communication method according to any possible implementation of the first aspect to the fourth aspect.

According to a twelfth aspect, a computer program product is provided. The computer program product includes a computer program or instructions. When the computer program or the instructions are run on a computer, the computer is enabled to perform the communication method according to any possible implementation of the first aspect to the fourth aspect.

### BRIEF DESCRIPTION OF THE DRAWINGS

FIG. 1 is a schematic diagram of an architecture of a communication system according to an embodiment of this application;

FIG. 2 is a schematic flowchart 1 of a communication method according to an embodiment of this application;

FIG. 3 is an example 1 of first indication information and second indication information according to an embodiment of this application;

FIG. 4 is an example 2 of first indication information and second indication information according to an embodiment of this application;

FIG. 5 is a schematic flowchart 2 of a communication method according to an embodiment of this application;

FIG. 6 is an example of an application scenario in which a first configuration matches a first DRX configuration according to an embodiment of this application;

FIG. 7 is an example 1 of an application scenario in which a first configuration mismatches a first DRX configuration according to an embodiment of this application;

FIG. 8 is an example 2 of an application scenario in which a first configuration mismatches a first DRX configuration according to an embodiment of this application;

FIG. 9 is an example 3 of an application scenario in which a first configuration mismatches a first DRX configuration according to an embodiment of this application;

FIG. 10 is a schematic diagram 1 depicting a structure of a communication apparatus according to an embodiment of this application;

FIG. 11 is a schematic diagram 2 depicting a structure of a communication apparatus according to an embodiment of this application; and

FIG. 12 is a schematic diagram 3 depicting a structure of a communication apparatus according to an embodiment of this application.

### DETAILED DESCRIPTION OF ILLUSTRATIVE EMBODIMENTS

The following describes technical solutions of this application with reference to accompanying drawings.

The technical solutions in embodiments of this application may be applied to various communication systems, for example, a wireless fidelity (wireless fidelity, Wi-Fi) system, a vehicle to everything (vehicle to everything, V2X) communication system, a device-to-device (device-to-device, D2D) communication system, an Internet of Vehicles communication system, a 4th generation (4th generation, 4G) mobile communication system such as a long term evolution (long term evolution, LTE) system and a worldwide interoperability for microwave access (worldwide interoperability for microwave access, WiMAX) communication system. a 5th generation (5th generation, 5G) mobile communication system such as a new radio (new radio, NR) system, and a future communication system such as a 6th generation (6th generation, 6G) mobile communication system.

All aspects, embodiments, or features are presented in this application by describing a system that may include a plurality of devices, components, modules, and the like. It should be appreciated and understood that, each system may include another device, component, module, and the like, and/or may not include all devices, components, modules, and the like discussed with reference to the accompany drawings. In addition, a combination of these solutions may be used.

In addition, in embodiments of this application, terms such as “example” and “for example” are used to represent giving an example, an illustration, or a description. Any embodiment or design scheme described as an “example” in this application should not be explained as being more preferred or having more advantages than another embodiment or design scheme. Exactly, the term “example” is used to present a concept in a specific manner.

In embodiments of this application, the terms “information (information)”, “signal (signal)”, “message (message)”, “channel (channel)”, and “signaling (signaling)” may sometimes be interchangeably used. It should be noted that, meanings expressed by the terms are consistent when differences between the terms are not emphasized. Terms “of (of)”, “corresponding or relevant (corresponding, relevant)”, and “corresponding (corresponding)” may sometimes be interchangeably used. It should be noted that meanings expressed by the terms are consistent when differences of the terms are not emphasized.

In embodiments of this application, sometimes a subscript, for example, W₁, may be written in an incorrect form, for example, W1. Expressed meanings are consistent when differences are not emphasized.

A network architecture and a service scenario that are described in embodiments of this application are intended to describe the technical solutions in embodiments of this application more clearly, and do not constitute a limitation on the technical solutions provided in embodiments of this application. A person of ordinary skill in the art may know that, with evolution of the network architecture and emergence of new service scenarios, the technical solutions provided in embodiments of this application are also applicable to similar technical problems.

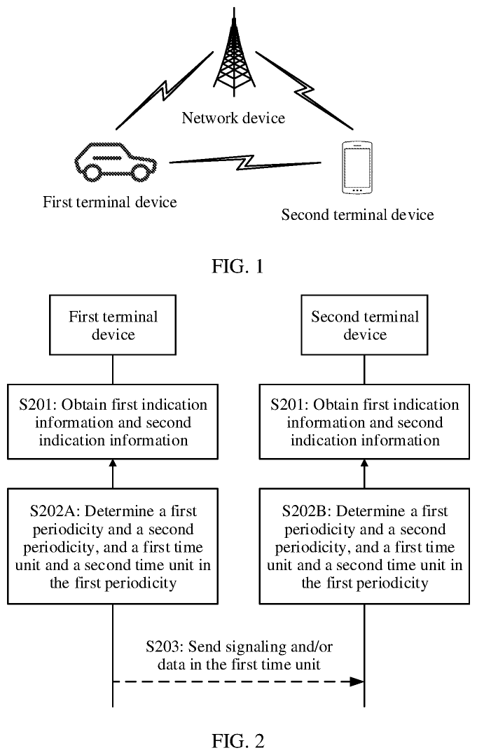

For example, FIG. 1 is a schematic diagram of an architecture of a communication system applicable to a communication method according to an embodiment of this application. For ease of understanding embodiments of this application, a communication system shown in FIG. 1 is first used as an example to describe in detail a communication system applicable to embodiments of this application. It should be noted that the solutions in embodiments of this application may also be applied to another mobile communication system, and a corresponding name may also be replaced with a name of a corresponding function in the another mobile communication system.

As shown in FIG. 1, the communication system includes a first terminal device and a second terminal device. Optionally, the communication system may further include a network device.

The terminal device, for example, the first terminal device and the second terminal device, may be a terminal device that accesses the communication system and has a wireless transceiver function, or a chip or a chip system that can be disposed in the terminal device. The terminal device may also be referred to as a user apparatus, an access terminal device, a user unit, a user station, a mobile station, a mobile console, a remote station, a remote terminal device, a mobile device, a user terminal device, a terminal device, a wireless communication device, a user agent, or a user apparatus. The terminal device in embodiments of this application may be a mobile phone (mobile phone), a tablet computer (pad), a computer with a wireless transceiver function, a virtual reality (virtual reality, VR) terminal device, an augmented reality (augmented reality, AR) terminal device, a wireless terminal device in industrial control (industrial control), a wireless terminal device in self driving (self driving), a wireless terminal device in telemedicine (remote medical), a wireless terminal device in smart grid (smart grid), a wireless terminal device in transportation safety (transportation safety), a wireless terminal device in smart city (smart city), a wireless terminal device in smart home (smart home), a vehicle-mounted terminal device, an RSU with a terminal device function, and the like. The terminal device in this application may alternatively be a vehicle-mounted module, a vehicle-mounted component, an onboard component, a vehicle-mounted chip, or a vehicle-mounted unit that is built in a vehicle as one or more components or units. The vehicle uses the vehicle-mounted module, the vehicle-mounted component, the onboard component, the vehicle-mounted chip, or the vehicle-mounted unit that is built in the vehicle, to implement the communication method provided in this application.

Optionally, the network device is a device that is located on a network side of the communication system and that has a wireless transceiver function, or a chip or a chip system that can be disposed in the device. The network device includes but is not limited to: an access point (access point, AP) in a wireless fidelity (wireless fidelity, Wi-Fi) system, such as a home gateway, a router, a server, a switch, and a bridge, an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, a home evolved NodeB, or a home NodeB, HNB), a baseband unit (baseband unit, BBU), a wireless relay node, a wireless backhaul node, a transmission point (transmission and reception point, TRP; or transmission point, TP), or the like. The network device may alternatively be a gNB or a transmission point (TRP or TP) in a 5G system, for example, a new radio (new radio, NR) system, or one antenna panel or a group of antenna panels (including a plurality of antenna panels) of a base station in a 5G system. The network device may alternatively be a network node, such as a baseband unit (BBU), a distributed unit (distributed unit, DU), or a road side unit (road side unit, RSU) having a base station function, that constitutes a gNB or a transmission point.

It should be understood that FIG. 1 is merely a simplified schematic diagram used as an example for ease of understanding. The communication system may further include another network device and/or another terminal device not shown in FIG. 1.

It should be noted that the communication methods provided in embodiments of this application may be applied between any two nodes shown in FIG. 1, for example, between terminal devices, between network devices, or between a terminal device and a network device. For communication between terminal devices, if there is a network device, it is considered as a scenario with network coverage. If there is no network device, it is considered as a scenario without network coverage. In the scenario with network coverage, communication between terminal devices may be performed by using a resource configured by the network device. In the scenario without network coverage, communication between terminal devices may be performed by using a preconfigured or predefined resource.

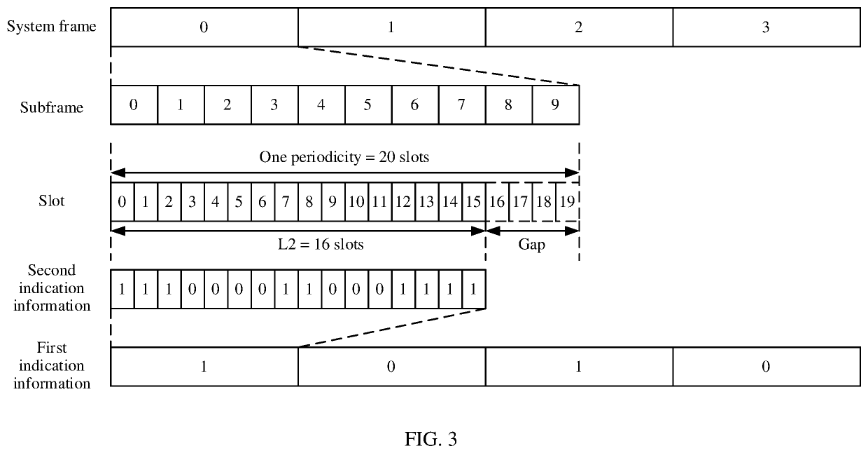

The following describes in detail the communication methods provided in embodiments of this application with reference to FIG. 2 to FIG. 9.

For example, FIG. 2 is a schematic flowchart 1 of a communication method according to an embodiment of this application. The communication method may be applicable to a wakeup/sleep operation of any terminal device shown in FIG. 1. Further, the any terminal device may send signaling and/or data to another terminal device in a wakeup time period, or receive signaling and/or data from another terminal device, to implement communication between terminal devices. With reference to FIG. 2, the following uses an example in which a first terminal device is a terminal device of publication and a second terminal device is a terminal device of monitoring for detailed description.

As shown in FIG. 2, the communication method includes the following steps.

S201: A first terminal device and a second terminal device obtain first indication information and second indication information.

For the first terminal device, the first indication information indicates a first periodicity for sending signaling and/or data and a second periodicity for not sending signaling and data, and the second indication information indicates a first time unit for sending signaling and/or data and a second time unit for not sending signaling and data in the first periodicity. In other words, for the first terminal device, the first indication information and the second indication information are used by the first terminal device to determine a publication time period and a sleep time period.

Correspondingly, for the second terminal device, the first indication information indicates a first periodicity for receiving signaling and/or data and a second periodicity for not receiving signaling and data, and the second indication information indicates a first time unit for receiving signaling and/or data and a second time unit for not receiving signaling and data in the first periodicity. In other words, for the second terminal device, the first indication information and/or the second indication information are/is used by the second terminal device to determine a monitoring time period and a sleep time period.

In a possible design solution, the first indication information may include L1 indication fields. The L1 indication fields correspond to L1 periodicities, and the L1 periodicities include the first periodicity and the second periodicity.

Similarly, the second indication information may include L2 indication fields. The L2 indication fields correspond to L2 time units included in the first periodicity, and the L2 time units include the first time unit and the second time unit.

Alternatively,

In a possible design solution, the first indication information may include L1 indication fields, and the L1 indication fields correspond to L1 continuous periodicities, indicating that the terminal device needs to monitor data/signaling or skip monitoring data/signaling in a periodicity corresponding to each indication field; or indicating that the terminal device may send data/signaling or skip sending data/signaling in a periodicity corresponding to each indication field.

Similarly, the second indication information may include L2 indication fields, and the L2 indication fields correspond to L2 continuous time units included in the first periodicity, and indicate that the terminal device needs to monitor data/signaling or skip monitoring data/signaling in a time unit corresponding to each indication field; or indicating that the terminal device may send data/signaling or skip sending data/signaling in a periodicity corresponding to each indication field.

Optionally, the first indication information and the second indication information may be implemented in a two-level bit mapping manner. For example, the L1 indication fields may be L1 bits, indicating time-domain locations of the first periodicity and the second periodicity in the L1 continuous periodicities. The L2 indication fields may be L2 bits, indicating the first time unit and the second time unit in the first periodicity.

For example, a time length of the first periodicity may be greater than or equal to a time length of the L2 continuous time units. When the time length of the first periodicity is greater than the time length of the L2 continuous time units, it may be considered that there is a gap between two groups of time units included in two adjacent periodicities. In other words, the two groups of time units are discontinuous. When the time length of the first periodicity is equal to the time length of the L2 continuous time units, it may be considered that there is no time interval between two groups of time units included in two adjacent periodicities. In other words, the two groups of time units are continuous.

In this embodiment of this application, the periodicity, for example, the first periodicity and the second periodicity, may include a plurality of continuous time units. The time unit may be one or more of the following: a system frame, a direct frame, a subframe, a slot, a short slot, and a symbol.

It should be noted that a time length of a periodicity may be defined by using a quantity of time units included in the periodicity. For example, one time unit may be one slot, and a time length of one periodicity is 20 slots (that is, one system frame) or 16 slots. The following examples are separately used for description.

For example, FIG. 3 is an example 1 of the first indication information and the second indication information according to an embodiment of this application. With reference to FIG. 3, the following specifically describes how to determine the first periodicity and the second periodicity, and how to determine the first time unit and the second time unit in the first periodicity.

As shown in FIG. 3, a time length of one periodicity is one system frame, that is, 20 slots. A length of the first indication information is 4 bits, that is, L1=4. Values of the 4 bits are sequentially {1,0,1,0} from left to right, respectively corresponding to four continuous periodicities in a time sequence, and corresponding system frame numbers (system frame number, SFN) are 0 to 3. To be specific, a start location of the four continuous periodicities is aligned with a frame header of the 1st system frame (that is, a system frame with SFN=0). It is assumed that a bit value 1 indicates that the terminal device needs to wake up in a periodicity corresponding to the bit, and a bit value 0 indicates that the terminal device needs to sleep in a periodicity corresponding to the bit. It can be learned with reference to FIG. 3 that the terminal device needs to wake up in periodicities with periodicity numbers {0,2}, that is, the 1st periodicity and the 3^{rd} periodicity are first periodicities, and the terminal device needs to sleep in periodicities with periodicity numbers {1,3}, that is, the 2nd periodicity and the 4^{th} periodicity are second periodicities.

Similarly, as shown in FIG. 3, a length of the second indication information is 16 bits, that is, L2=16. Values of the 16 bits are sequentially {1,1,1,0,0,0,0,1,1,0,0,0,1,1,1,1} from left to right, and respectively correspond to 16 slots with frontmost time-domain location in any first periodicity. It is assumed that a bit value 1 indicates that the terminal device needs to wake up in a time unit corresponding to the bit in a first periodicity, and a bit value 0 indicates that the terminal device needs to sleep in a time unit corresponding to the bit in the first periodicity. With reference to FIG. 3, it can be learned that the terminal device needs to wake up in slots with slot numbers {0,1,2,7,8,12,13,14,15}, that is, the 1st to the 3^{rd}, the 8^{th} to the 9^{th}, and the 13^{th} to the 16th slots are first time units, and the terminal device needs to sleep in slots with slot numbers {3,4,5,6,9,10,11}, that is, the 4^{th} to the 7^{th}, and the loth to the 12^{th} slots are second time units.

It should be noted that, in the example of the first indication information and the second indication information shown in FIG. 3, the time length of the L2 continuous time units corresponding to the second indication information is less than a time length P of one periodicity, that is, L2<P. In this case, there is a gap between two adjacent groups of L2 continuous time units. During actual application, the time length of the L2 continuous time units corresponding to the second indication information may also be equal to the time length P of one periodicity, that is, L2=P. In this case, there is no gap between two adjacent groups of L2 continuous time units. The following uses an example for description.

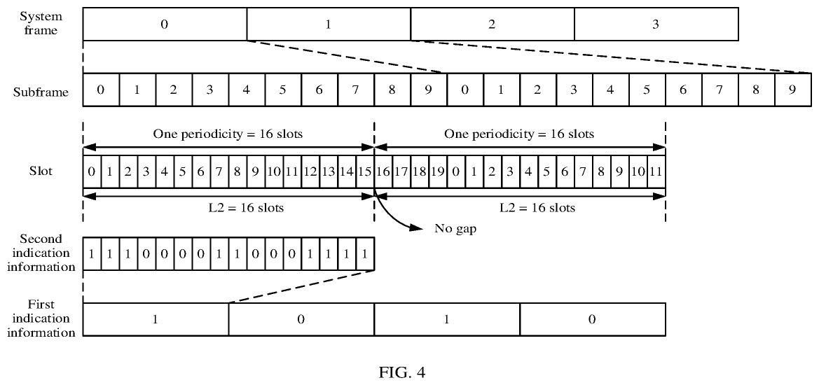

For example, FIG. 4 is an example 2 of the first indication information and the second indication information according to an embodiment of this application. With reference to FIG. 4, the following specifically describes how to determine the first periodicity and the second periodicity, and how to determine the first time unit and the second time unit in the first periodicity.

As shown in FIG. 4, a time length of one periodicity is 16 slots. A length of the first indication information is 4 bits, that is, L1=4. Values of the 4 bits are sequentially {1,0,1,0} from left to right, respectively corresponding to four continuous periodicities in a time sequence, and a start location of the 1st periodicity of the four continuous periodicities is aligned with a frame header of the 1st system frame (that is, a system frame with SFN=0). Optionally, there is an offset value between the start location of the periodicity and the frame header of the 1st system frame (that is, the system frame with SFN=0), that is, the start location of the periodicity is the system frame with SFN=0 plus the offset value. It is assumed that a bit value 1 indicates that the terminal device needs to wake up in a periodicity corresponding to the bit, and a bit value 0 indicates that the terminal device needs to sleep in a periodicity corresponding to the bit. It can be learned with reference to FIG. 4 that the terminal device needs to wake up in periodicities with periodicity numbers {0,2}, that is, the 1st periodicity and the 3^{rd} periodicity are first periodicities, and the terminal device needs to sleep in periodicities with periodicity numbers {1,3}, that is, the 2^{nd} periodicity and the 4^{th} periodicity are second periodicities.

Similarly, as shown in FIG. 4, a length of the second indication information is 16 bits, that is, L2=16. Values of the 16 bits are sequentially {1,1,1,0,0,0,0,1,1,0,0,0,1,1,1,1} from left to right, and respectively correspond to all 16 slots in any first periodicity. It is assumed that a bit value 1 indicates that the terminal device needs to wake up in a time unit corresponding to the bit in a first periodicity, and a bit value 0 indicates that the terminal device needs to sleep in a time unit corresponding to the bit in the first periodicity. With reference to FIG. 4, it can be learned that the terminal device needs to wake up in slots with slot numbers {0,1,2,7,8,12,13,14,15}, that is, the 1st to the 3^{rd}, the 8th to the 9^{th}, and the 13^{th} to the 16^{th} slots are first time units, and the terminal device needs to sleep in slots with slot numbers {3,4,5,6,9,10,11}, that is, the 4^{th} to the 7^{th}, and the 10^{th} to the 12^{th} slots are second time units.

It can be seen from FIG. 3 and FIG. 4 that there is a gap between two adjacent groups of L2 continuous time units shown in FIG. 3, but there is no gap between two adjacent groups of L2 continuous time units shown in FIG. 4. In addition, sleep needs to be performed in an entire second periodicity. Therefore, there is no need to determine whether a time unit included in a second periodicity is a first time unit or a second time unit. In other words, the first time unit and the second time unit may be considered as being defined for the first periodicity in which the terminal device needs to wake up, and are irrelevant to the second periodicity. Alternatively, it may be understood that all time units included in a second periodicity are considered as second time units.

It should be noted that in the two examples of the first indication information and the second indication information shown in FIG. 3 and FIG. 4, the time unit is described by using a slot as an example. It should be understood that the time unit may alternatively be in another unit in terms of time, provided that it is ensured that one periodicity includes one or more time units. This is not specifically limited in this embodiment of this application. For example, when the periodicity is a system frame or a direct frame, the time unit may be one of a subframe, a slot, a short slot, or a symbol. For another example, when the periodicity is a subframe, a slot, or a short slot, the time unit may be a symbol.

In this embodiment of this application, the periodicity number indicated by the first indication information indicates a periodicity offset of a periodicity in the L1 periodicities, and the time unit number indicated by the second indication information indicates a time unit offset of a time unit in the first periodicity in the L2 continuous time units included in the first periodicity. Both are relative time-domain locations. Specifically, a {p,u} manner may be used for representation, where p represents a periodicity offset of a periodicity in which a time unit is located in the L1 periodicities, and u represents a time unit offset of the time unit in the L2 continuous time units included in a periodicity in which the time unit is located. Therefore, an actual time-domain location of each time unit in a time period further needs to be converted into the relative time-domain location, and the first indication information and the second indication information are queried based on the relative time-domain location, to determine whether each periodicity in the time period is a first periodicity or a second periodicity, and determine whether each time unit in the first periodicity is a first time unit or a second time unit. In other words, the following S202A and S202B are performed.

S202A: Optionally, the first terminal device determines a first periodicity and a second periodicity, and a first time unit and a second time unit in the first periodicity.

S202B: Optionally, the second terminal device determines a first periodicity and a second periodicity, and a first time unit and a second time unit in the first periodicity.

With reference to FIG. 3 and FIG. 4, the following uses examples to describe how to determine the first periodicity and the second periodicity, and how to determine the first time unit and the second time unit in the first periodicity. The following uses an example in which the time unit is a slot for description.

It should be noted that the examples shown in FIG. 3 and FIG. 4 and the following formula (i) to formula (8) are all used as examples to describe the technical solutions provided in embodiments of this application, and should not be considered as a limitation on the technical solutions provided in embodiments of this application. For example, parameters involved in the formula (i) to formula (8) may be correspondingly adjusted due to different communication standards, different frame structures of a same communications standard, different periodicities and/or different time units defined for a same frame structure, or the like. However, the adjustment should not be considered as a limitation on the formula (i) to formula (8).

Specifically, when the start time-domain location of the first periodicity in the L1 periodicities is aligned with the frame header of the 1st system frame (that is, the system frame with SFN=0), the periodicity offset may be calculated according to the following formula (1), and the first periodicity and the second periodicity are determined based on the periodicity offset and the first indication information. Then the time unit offset is calculated according to the formula (2), and the first time unit and the second time unit in the first periodicity are determined based on the time unit offset and the second indication information.

p=mod{floor[(n_{sfn}×N_{slotinfrm}+nₛₗₒₜ)]/P,L1} (1)

u=mod{[n_{sfn}×N_{slotinfrm}+nₛₗₒₜ],P} (2)

{n_{sfn},nₛₗₒₜ} represents an actual time-domain location of a current slot, n_{sfn} is a system frame number or a direct frame number, nₛₗₒₜ is a slot number, N_{slotinfrm} is a quantity of slots included in one system frame, L1 is a quantity of periodicities corresponding to the first indication information, P is a quantity of slots included in each of the L1 periodicities, L2 is a quantity of slots corresponding to the second indication information, {p,u} represents a relative time-domain location of the slot in the L1 periodicities, p is a relative periodicity number (a value ranges from 0 to L1−1) of a slot with an actual time-domain location {n_{sfn},nₛₗₒₜ} in the L1 periodicities, and u is a relative slot number (a value ranges from 0 to L2−1) of a slot with an actual time-domain location {n_{sfn},nₛₗₒₜ} in the L2 slots corresponding to the second indication information if the slot with the actual time-domain location {n_{sfn},nₛₗₒₜ} is located in a first periodicity of the L1 periodicities. P is greater than or equal to L2, floor( ) represents a rounding down operation, and mod( ) is a modulo operation.

The following uses several examples to describe how to determine, according to the formula (i) and formula (2), whether the terminal device needs to wake up in a slot with an actual time-domain location {n_{sfn},nₛₗₒₜ}.

Example 1: It is assumed that L1=4, the first indication information is {1,0,1,0}, L2=16, the second indication information is {1,1,1,0,0,0,0,1,1,0,0,0,1,1,1,1}, P=20, N_{slotinfrm}=20, and an actual time-domain location of a slot A is {n_{sfn}=2, nₛₗₒₜ=12}. The following can be learned according to the formula (1):

p=mod{floor[(2×20+12)/20],4}=mod{floor[52/20],4}=2.

The first indication information corresponding to p=2 is 1. That is, a periodicity in which the slot A is located is a first periodicity, and the terminal device needs to wake up.

Then, the following can be learned according to the formula (2):

u=mod{[2×20+12],20}=mod{52,20}=12.

The second indication information corresponding to u=12 is 1. That is, it is finally determined that the terminal device needs to wake up in the slot A.

Alternatively, because a first periodicity is equal to one radio frame, and the first periodicity is aligned with the radio frame, the terminal device may not calculate a relative slot of a current slot according to the formula (2), but determine, based on a slot number of the current slot and the first indication information, whether the terminal device needs to wake up in the current slot. For example, if a slot index is aligned with an indication information index, the terminal device determines, based on an index of a current slot and a value of the second indication information corresponding to the index, whether the terminal device needs to wake up in the current slot. For example, the index of the slot A is 12. The second indication information corresponding to u=12 is 1. That is, it is determined that the terminal device needs to wake up in the slot A. For another example, if there is a deviation between the slot index and the indication information index, that is, slot index numbers are 0 to 19, and index numbers included in the second indication information is 1 to 20, the index of the current slot is 12. The second indication information corresponding to u=12+1=1.3 is 1. That is, it is determined that the terminal device needs to wake up in the slot A. For still another example, the index of the current slot is 12. The second indication information corresponding to u=12−1=11 is 0. That is, it is determined that the terminal device does not need to wake up in the slot A.

Example 2: It is assumed that values of L1, the first indication information, L2, the second indication information, P, and N_{slotinfrm} are all the same as those in Example 1, and an actual time-domain location of a slot B is {n_{sfn}=4,nₛₗₒₜ=5} The following can be learned according to the formula (1):

p=mod{floor[(4×20+5)/20],4}=mod{floor[85/20],4}=0.

The first indication information corresponding to p=0 is 1. That is, a periodicity in which the slot B is located is a first periodicity, and the terminal device needs to wake up.

Then, the following can be learned according to the formula (2):

u=mod{[4×20+5],20}=mod{85,20}=5.

The second indication information corresponding to u=5 is 0. That is, it is finally determined that the terminal device needs to wake up in the slot B.

Alternatively, as described in Example 1, the slot number of the current slot is used as the index of the second indication information, and it is found that the second indication information corresponding to u=5 is 0. That is, it is finally determined that the terminal device needs to sleep in the slot B.

Example 3: It is assumed that values of L1, the first indication information, L2, the second indication information, P, and N_{slotinfrm} are all the same as those in Example 1, and a time-domain location of a slot C is {n_{sfn}=5,nₛₗₒₜ=12}. The following can be learned according to the formula (1):

p=mod{floor[(5×20+18)/20],4}=mod{floor[118/20],4}=1.

The first indication information corresponding to p=1 is 0. That is, a periodicity in which the slot C is located is a second periodicity, and the terminal device needs to sleep.

It should be noted that, because the slot C is located in a second periodicity, determining does not need to be performed according to the formula (2) and the second indication information in this case, and it may be directly determined that the terminal device needs to sleep in the slot C. Example 4: It is assumed that values of L1, the first indication information, L2, the second indication information, P, and N_{slotinfrm} are all the same as those in Example 1, and a time-domain location of a slot D is {n_{sfn}=6,nₛₗₒₜ=18}. The following can be learned according to the formula (1):

p=mod{floor[(6×20+18)/20],4}=mod{floor[138/20],4}=2.

The first indication information corresponding to p=2 is 1. That is, a periodicity in which the slot D is located is a first periodicity, and the terminal device needs to wake up.

Then, the following can be learned according to the formula (2):

u=mod{[6×20+18],20}=mod{138,20}=18. u=18>L2=16.

No corresponding second indication information is configured or defined. That is, the slot D is located in a GAP. In this case, whether the terminal device wakes up or sleeps in the slot D may be determined based on an actual communication requirement. For example, it may be determined based on whether there is a communication requirement between the terminal device and the network side. If there is a communication requirement between the terminal device and the network side, the terminal device wakes up. Otherwise, the terminal device sleeps.

Alternatively, if a retransmission timer is still running in the slot D, for example, the retransmission timer is not stopped or does not expire, the terminal device wakes up. Otherwise, the terminal device sleeps.

Alternatively, when the slot D is in a GAP, the terminal device sleeps. For example, the terminal device does not monitor a PSCCH and/or a PSSCH, but keeps monitoring a PDCCH. Alternatively, when the slot D is in a GAP, the terminal device wakes up.

It should be noted that the start time-domain location of the 1^{st} periodicity in the L1 periodicities shown in FIG. 3 is aligned with the frame header of the 1^{st} system frame (that is, the system frame with SFN=0). That is, {N_{sfn_ofst},N_{sfn_ofst}} corresponding to the start time-domain location of the 1^{st} periodicity is {0,0}. N_{sfn_ofst} is a system frame offset corresponding to the start time-domain location of the 1^{st} periodicity, and N_{sfn_ofst} is a slot offset corresponding to the start time-domain location of the 1^{st} periodicity. It should be understood that the start time-domain location of the 1^{st} periodicity may not be aligned with the 1^{st} system frame. Details are described below.

When the start time-domain location of the 1^{st} periodicity in the L1 periodicities is not aligned with the 1^{st} system frame, the first periodicity and the second periodicity may be determined according to the following formula (3) and the first indication information, and the first time unit and the second time unit in the first periodicity are determined according to the formula (4) and the second indication information:

p=mod{floor{[d_{sfn}×N_{slotinfrm}+dₛₗₒₜ]P},L1} (3)

u=mod{[d_{sfn}×N_{slotinfrm}+dₛₗₒₜ],P} (4)

N_{slotinfrm} is a quantity of slots included in one system frame, P is a quantity of slots included in each of L1 periodicities, L1 is a quantity of periodicities corresponding to the first indication information, {p,u} represents a relative time-domain location of the slot in the L1 periodicities, p is a relative periodicity number (a value ranges from 0 to L1−1) of a slot with an actual time-domain location {n_{sfn},nₛₗₒₜ} in the L1 periodicities, and u is a relative slot number (a value ranges from 0 to L2−1) of a slot with an actual time-domain location {n_{sfn},nₛₗₒₜ} in L2 continuous slots corresponding to the second indication information if the slot with the actual time-domain location {n_{sfn},nₛₗₒₜ} is located in a first periodicity of the L1 periodicities. P is greater than or equal to L2, floor( ) represents a rounding down operation, and mod( ) is a modulo operation.

{n_{sfn},nₛₗₒₜ} represents an actual time-domain location of a current slot, n_{sfn} is a system frame number, nₛₗₒₜ is a slot number of the current slot, d_{sfn} is a system frame deviation (difference) between the current slot and a start time-domain location {N_{sfn_ofst},N_{slot_ofst}} of the 1^{st} periodicity in the L1 periodicities, and dₛₗₒₜ is a slot deviation between the current slot and the start time-domain location of the 1^{st} periodicity in the L1 periodicities, N_{sfn_ofst} is a system frame offset between the start time-domain location of the 1^{st} periodicity in the L1 periodicities and the frame header of the 1^{st} system frame, and N_{slot_ofst} is a slot offset between the start time-domain location of the 1^{st} periodicity in the L1 periodicities and the frame header of the 1^{st} system frame. In this case, d_{sfn} can be calculated according to the following formula (5) or formula (6), and dₛₗₒₜ can be calculated according to the following formula (7) or formula (8).

Specifically, if n_{sfn} is greater than or equal to N_{sfn_ofst}, d_{sfn} is calculated according to the following formula (5):

d_{sfn}=n_{sfn}−N_{sfn_ofst} (5)

Otherwise, that is, if n_{sfn} is less than N_{sfn_ofst}, d_{sfn} is calculated according to the following formula (6):

d_{sfn}=N_{sfn}+n_{sfn}−N_{sfn_ofst} (6)

N_{sfn} is a total quantity of system frames included in one system frame periodicity. For LTE, N_{sfn}=1024.

Similarly, if nₛₗₒₜ is greater than or equal to N_{slot_ofst}, d_{sfn} is calculated according to the following formula (7):

dₛₗₒₜ=nₛₗₒₜ−N_{slot_ofst} (7)

Otherwise, that is, if n_{sfn} is less than N_{sfn_ofst}, dₛₗₒₜ is calculated according to the following formula (8):

dₛₗₒₜ=Nₛₗₒₜ+nₛₗₒₜ−N_{slot_ofst} (8)

Nₛₗₒₜ is a total quantity of slots included in one system frame. For LTE, Nₛₗₒₜ=20.

The following uses an example for description.

Example 5: It is assumed that values of L1, the first indication information, L2, the second indication information, P, and N_{slotinfrm} are all the same as those in Example 1. N_{sfn_ofst}=3, N_{slot_ofst}=8, and an actual time-domain location of a slot E is {n_{sfn}=5,nₛₗₒₜ=17}. The following can be learned according to the formula (5), formula (7), and formula (3):

d_{sfn}=5−3=2,

dₛₗₒₜ=17−8=9, and

p=mod{floor{[2×20+9]/20},4}=mod{floor{[49]/20},4}=2.

The first indication information corresponding to p=2 is 1. That is, a periodicity in which the slot E is located is a first periodicity, and the terminal device needs to wake up.

Then, the following can be learned according to the formula (4):

u=mod{[2×20+9],20}=mod{49,20}=9.

The second indication information corresponding to u=9 is 0. That is, it is finally determined that the terminal device needs to sleep in the slot E.

Example 6: It is assumed that values of L1, the first indication information, L2, the second indication information, P, and N_{slotinfrm} are all the same as those in Example 1. N_{sfn_ofst}=1022, N_{slot_ofst}=8, and an actual time-domain location of a slot F is {n_{sfn}=2,nₛₗₒₜ=0}. The following can be learned according to the formula (6), formula (8), and formula (3):

d_{sfn}=1024+2−1022=4,

dₛₗₒₜ=20+0−8=12, and

p=mod{floor{[4×20+12]/20},4}=mod{floor{[92]/20},4}=0.

The first indication information corresponding to p=0 is 1. That is, a periodicity in which the slot F is located is a first periodicity, and the terminal device needs to wake up.

Then, the following can be learned according to the formula (4):

u=mod{[4×20+12],20}=mod{[92],20}=12.

The second indication information corresponding to u=12 is 1. That is, it is finally determined that terminal device needs to wake up in the slot F.

It should be noted that the foregoing formula (2) to formula (8) are also applicable to a case in which P<N_{slotinfr}. The following uses examples for description.

Example 7: It is assumed that values of L1, the first indication information, L2, the second indication information, and N_{slotinfrm} are all the same as those in Example 5. P=16, N_{sfn_ofst}=3, N_{slot_ofst}=8, and an actual time-domain location of a slot G is {n_{sfn}=7,nₛₗₒₜ=16}. The following can be learned according to the formula (5), formula (7), and formula (3):

d_{sfn}=5−3=2,

dₛₗₒₜ=16−8=8, and

p=mod{floor{[2×20+8]/16},4}=mod{floor{[48]/16},4}=0.

The first indication information corresponding to p=0 is 1. That is, a periodicity in which the slot G is located is a first periodicity, and the terminal device needs to wake up.

Then, the following can be learned according to the formula (4):

u=mod{[2×20+8],16}=mod{48,16}=0.

The second indication information corresponding to u=0 is 1. That is, it is finally determined that the terminal device needs to wake up in the slot G.

Example 8: It is assumed that values of L1, the first indication information, L2, the second indication information, P, and N_{slotinfrm} are all the same as those in Example 7. N_{sfn_ofst}=1023, N_{slot_ofst}=8, and an actual time-domain location of a slot H is {n_{sfn}=3,nₛₗₒₜ=17}. The following can be learned according to the formula (6), formula (7), and formula (3):

d_{sfn}=1024+3−1023=4,

dₛₗₒₜ=17−8=9, and

p=mod{floor{[4×20+9]/16},4}=mod{floor{[89]/16},4}=1.

The first indication information corresponding to p=1 is 0. That is, a periodicity in which the slot H is located is a second periodicity, and the terminal device needs to sleep.

It should be noted that the foregoing formulas (1) to (8) are described by using LTE as an example. Values of n_{sfn} and N_{sfn_ofst} are 0 to 1023, values of nₛₗₒₜ and N_{slot_ofst} are 0 to 19, N_{sfn}=1024, and N_{slotinfrm}=20. It should be understood that, frame structures may vary with different communication systems or configurations. Therefore, values of the parameters in the foregoing formula (1) to formula (8) may be different. A communication system to which the foregoing formula (1) to formula (6) are applicable is not specifically limited in this embodiment of this application.

Optionally, even for a same frame format used by communication systems of a same standard, if selected time units are different and/or definitions of periodicities are different, the foregoing formula (1) to formula (8) may also change. The following uses an example for description.

In an example of NR, one system frame=10 slots. If it is defined that one time unit=one slot and one periodicity=one system frame, in the foregoing formula (1) to formula (8), value ranges of nₛₗₒₜ and N_{slot_ofst} are 0 to 9, and N_{slotinfrm}=10.

Further, still in an example of LTE, one slot=seven symbols. If it is defined that one time unit=one symbol and one periodicity=one system frame, in the foregoing formula (1) to formula (8), P=140.

In the foregoing Example 1 to Example 8, whether the current slot is in the first periodicity is first determined based on the first indication information. If the current slot is in the first periodicity, whether the current slot is the first time unit is determined based on the second indication information, to determine whether the terminal device needs to wake up or sleep in the current slot. It should be understood that, whether the current slot is the first time unit may alternatively be first determined based on the second indication information. If the current slot is the first time unit, whether the current slot is in the first periodicity is then determined based on the first indication information, to determine whether the terminal device needs to wake up in the current slot. In other words, a sequence of using the first indication information and the second indication information is not specifically limited in this embodiment of this application.

It should be noted that a sequence in which the first terminal device performs S201 and S202A and the second terminal device performs S201 and S202B is not limited in this embodiment of this application. For ease of description, S201 performed by the first terminal device is named S201A, and S201 performed by the second terminal device is named S201B. In this case, S201A and S202A may be performed before or after S201B and S202B, or the steps may be alternately performed, for example, S201A-S201B-S202B-S202A and S201A-S201B-S202A-S202B. Further, some steps may also be performed at the same time. For example, S201A and S201B are performed at the same time, and S202A and S202B are performed at the same time.

In this way, the terminal device, such as the first terminal device or the second terminal device, may determine, based on the first indication information and the second indication information, time units in which the terminal device needs to wake up and time units in which the terminal device needs to sleep, to reduce power consumption. Optionally, the terminal device may further communicate, based on this, with another terminal device or a network, for example, DTX and/or DRX, that is, may further perform the following S203.

S203: The first terminal device sends signaling and/or data in the first time unit. Correspondingly, the second terminal device receives the signaling and/or the data in the first time unit.

Optionally, the signaling and/or the data may be for SL communication. Further, the first indication information and the second indication information may be associated with a resource pool of the terminal device. For example, there is an overlapping window between the resource pool and the L1 periodicities in time domain. In this way, the terminal device may send or receive signaling and/or data on a resource in the resource pool associated with the first time unit, to implement SL communication with another terminal device.

It should be noted that a terminal device may simultaneously communicate with a plurality of terminal devices. When the terminal device simultaneously communicates with the plurality of terminal devices, signaling and/or data transmission directions between the terminal device and different terminal devices may be the same or different. This is not specifically limited in this embodiment of this application.

Based on the communication method in FIG. 2, the terminal device determines the first periodicity and the second periodicity based on the first indication information, and determines the first time unit and the second time unit in the first periodicity based on the second indication information. In this way, the terminal device may monitor signaling and/or data only in the first time unit in the first periodicity, that is, enter a wakeup state, and enter a sleep state in the second periodicity and the second time unit in the first periodicity. This implements discontinuous transmission and/or discontinuous reception of the terminal device, and reduces power consumption of the terminal device.

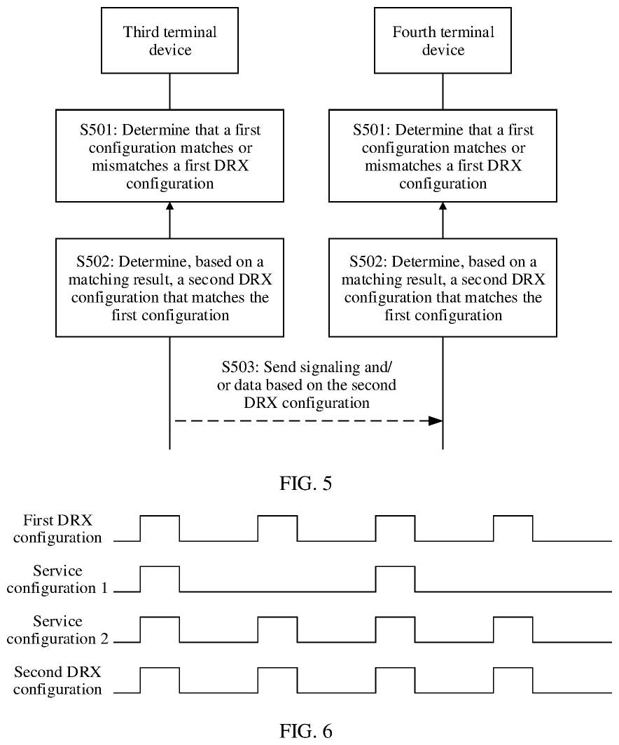

For example, FIG. 5 is a schematic flowchart 2 of a communication method according to an embodiment of this application. The communication method may be applicable to a DTX/DRX scenario in which a wakeup time period and a sleep time period of two terminal devices are adjusted, to implement SL communication between the terminal devices. A specific method for implementing wakeup/sleep may be implemented based on the communication method shown in FIG. 4, or may be implemented based on an existing implementation. This is not specifically limited in this embodiment of this application.

With reference to FIG. 5, the following uses an example in which a third terminal device is a terminal device of publication and a fourth terminal device is a terminal device of monitoring for detailed description. As shown in FIG. 5, the communication method includes the following steps.

S501: Optionally, a third terminal device and a fourth terminal device determine that a first configuration matches or mismatches a first DRX configuration.

The first configuration may include a service configuration and/or a resource pool configuration.

In this embodiment of this application, the first DRX configuration may include one or more preconfigured or predefined broadcast-dedicated DRX configurations (which may also be referred to as a default DRX configuration, a broadcast DRX configuration, or a common DRX configuration), and a cycle of the first DRX configuration is fixed and/or cannot be adjusted, so that different terminal devices in different access networks and different coverage areas send/receive SL messages, for example, broadcast messages, based on a same SL DRX configuration, to improve a monitoring success rate and improves SL communication efficiency. It should be understood that for each DRX configuration in the first DRX configuration, unified configuration may be implemented in one or more of the following ranges: all terminal devices in an entire network, all terminal devices in a coverage area of a specified access network device, all terminal devices using a specified scheduling mode, for example, an autonomous mode (mode 2), all terminal devices configured with a specified resource pool and/or a specified carrier, all terminal devices located in a specified geographical area, all terminal devices in a scheduling mode (mode 1), and the like. Specifically, a manner of protocol predefinition (for example, the terminal device is configured before delivery) or preconfiguration (for example, the terminal device is configured by a network during initial access) may be used for implementation. An implementation of the first DRX configuration is not specifically limited in this embodiment of this application.

For example, the first DRX configuration may include only one broadcast-dedicated DRX configuration. The third terminal device (TX) sends a broadcast message of one or more services based on the broadcast-dedicated SL DRX configuration. After receiving, based on the broadcast-dedicated SL DRX configuration, the broadcast message sent by the third terminal device, the fourth terminal device may establish SL communication with the third terminal device based on the broadcast message.

For another example, the first DRX configuration may also include a plurality of broadcast-dedicated DRX configurations. Each broadcast-dedicated DRX configuration is originally configured to separately send/receive a broadcast message of one or more services, that is, each broadcast-dedicated DRX configuration may correspond to one or more services. For example, the service may correspond to one or more pieces of the following information: a communication type (cast type), a source identifier (source L2 ID, or source L1 ID), and a destination identifier (destination L2 ID, or destination L1 ID). It is not limited to other information. In this scenario, the third terminal device may map broadcast services of a plurality of services that are originally configured to be sent by using different broadcast-dedicated DRX configurations to a same broadcast-dedicated DRX configuration, for example, a broadcast-dedicated DRX configuration with a smallest cycle, and send the broadcast services.

It should be understood that when the fourth terminal device is in an initial state, for example, when the fourth terminal device is just powered on or just enables SL communication, the fourth terminal device may not use an SL DRX function, that is, the fourth terminal device may keep monitoring a sidelink message. After detecting signaling or data corresponding to a service, the fourth terminal device enables (enable) the SL DRX function, and receives signaling and/or data of the service by using a service configuration corresponding to the service, for example, a cycle corresponding to the service or a DRX configuration that is the same as that maintained by the third terminal device, to keep the third terminal device and the fourth terminal device wake up and/or sleep in at least one same time unit, for example, a physical sidelink control channel (physical sidelink control channel, PSCCH) and a physical sidelink shared channel (physical sidelink shared channel, PSSCH).

Any one of the foregoing services may be unicast (unicast), multicast (multicast, also referred to as multicast), or broadcast (broadcast). The service configuration is a configuration for transmitting a service between terminal devices. The service configuration may be periodic, for example, a service DRX configuration, or may be aperiodic. This is not specifically limited in this embodiment of this application. The periodic service configuration may include parameters such as a service cycle, a traffic pattern (traffic pattern), and a time-domain location (a start location+an end location, or a start location+a wakeup time period window length, or a wakeup time period window length+an end location) of a wakeup time period.

The resource pool configuration is one or more groups of resources predefined, preconfigured, or configured (for example, configured by a base station by using system information or dedicated signaling) in the terminal device, and may be periodic or aperiodic. The terminal device may select one or more groups to implement SL communication with another terminal device. This is not specifically limited in this embodiment of this application. The periodic resource pool configuration may include parameters such as a resource pool periodicity, and a time-domain location and a frequency-domain location of an available resource.

In this embodiment of this application, that the first configuration matches the first DRX configuration may be understood as that there is an overlapping window between one or more wakeup time periods in the first configuration and one or more wakeup time periods in the first DRX configuration. The third terminal device and the fourth terminal device may send/receive signaling and/or data based on the overlapping window.

Similarly, that the first configuration mismatches the first DRX configuration may be understood as that there is no overlapping window between the wakeup time period in the first configuration and the wakeup time period in the first DRX configuration, or there is no overlapping window between a closest wakeup time period in the first configuration in time domain and a wakeup time period in the first DRX configuration close to a current moment. In this case, the third terminal device and the fourth terminal device need to correspondingly adjust the first configuration or the first DRX configuration, and send/receive signaling and/or data based on the adjusted first configuration and/or the adjusted first DRX configuration.

In this embodiment of this application, the wakeup time period may also be understood as a valid time period, that is, a time period that can be used by the terminal device, a time period in which the terminal device has an available resource, or a time period in which the terminal device can enable and use a transceiver module. The sleep time period may also be understood as an invalid time period, that is, a time period that cannot be used by the terminal device, or a time period in which the terminal device disables/does not use the transceiver module. The terminal device may communicate with another terminal device or network in the valid time period, and sleep in the sleep time period, to reduce power consumption.

For an example in which the first configuration matches or mismatches the first DRX configuration, refer to the following S502. Details are not described herein again.

S502. The third terminal device and the fourth terminal device determine, based on a matching result, a second DRX configuration that matches the first configuration.

In a possible design solution, determining, based on the matching result, the second DRX configuration that matches the first configuration may include: determining the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration. The first configuration may be a service configuration.

For example, FIG. 6 is an example of a service configuration and a first DRX configuration according to an embodiment of this application. As shown in FIG. 6, a cycle of the first DRX configuration is twice a service cycle 1 of a service configuration 1, the cycle of the first DRX configuration is equal to a service cycle 2 of a service configuration 2, and wakeup time periods corresponding to the first DRX configuration can cover wakeup time periods (or referred to as a service cycle) corresponding to the service configuration 1 and wakeup time periods (or referred to as a service cycle) corresponding to the service configuration 2. That is, the DRX cycle of the first DRX configuration corresponds to the service cycle corresponding to the first configuration. It may be considered that the first DRX configuration matches the service configuration 1 and the service configuration 2. In this way, the third terminal device and the fourth terminal device may determine the first DRX configuration as the second DRX configuration, to send/receive signaling and/or data of the service configuration 1 and the service configuration 2.

It should be noted that the wakeup time periods corresponding to the first DRX configuration shown in FIG. 6 may completely cover the wakeup time periods corresponding to the service configuration 1 and the service configuration 2. In an actual application, as long as an overlapping window exists between the wakeup time periods corresponding to the first DRX configuration and the wakeup time periods corresponding to the service configuration 1 and the wakeup time periods corresponding to the service configuration 2 respectively, and a resource in the overlapping window can be used to send/receive signaling and/or data respectively corresponding to the service configuration 1 and the service configuration 2, it may also be considered that the first DRX configuration matches the service configuration 1 and the service configuration 2.

In another possible design solution, determining, based on the matching result, the second DRX configuration that matches the first configuration may include: determining the second DRX configuration based on the first DRX configuration and/or the first configuration if the first configuration mismatches the first DRX configuration. The first configuration may be a resource pool configuration.

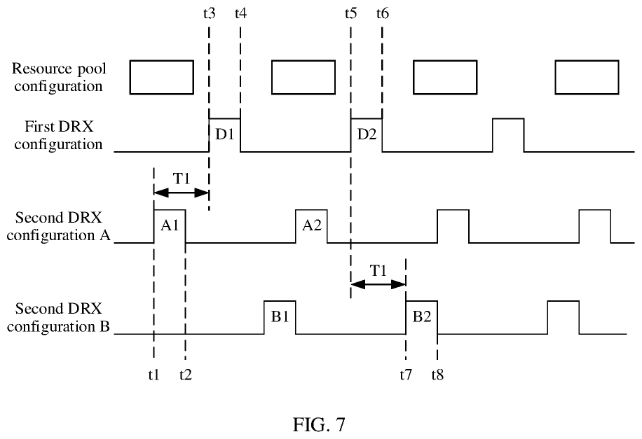

For example, FIG. 7 is an example 1 of a resource pool configuration and a first DRX configuration according to an embodiment of this application. As shown in FIG. 7, there is no overlapping window between wakeup time periods corresponding to the first DRX configuration and wakeup time periods corresponding to the resource pool configuration, that is, the first DRX configuration mismatches the resource pool configuration.

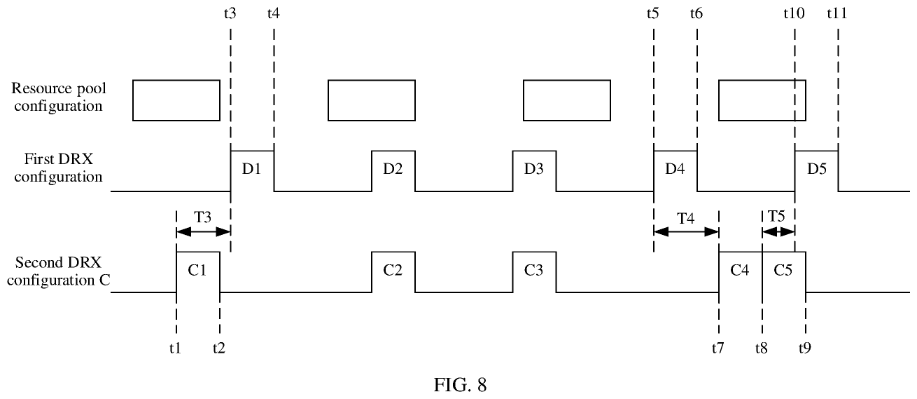

For example, FIG. 8 is an example 2 of a resource pool configuration and a first DRX configuration according to an embodiment of this application. As shown in FIG. 8, the first DRX configuration includes five wakeup time periods D1 to D5. The wakeup time periods D1 and D4 are outside a valid time period corresponding to the resource pool configuration, and it may be considered as mismatching. The wakeup time period D2 is within a wakeup time period corresponding to the resource pool configuration, that is, it is considered as matching. The wakeup time periods D3 and D5 partially overlap with wakeup periods corresponding to the resource pool configuration, and whether it is considered as matching may be determined based on an actual communication requirement. In other words, whether the resource pool configuration matches the first DRX configuration may be determined based on the wakeup time periods in the resource pool configuration and the first DRX configuration. Specifically, based on a matching result of all wakeup time periods in the resource pool configuration and the first DRX configuration, whether the resource pool configuration matches the first DRX configuration may include complete matching, partial matching, and complete mismatching.

It should be understood that, when there are mismatched wakeup time periods between the resource pool configuration and the first DRX configuration, a time-domain location of the wakeup time period corresponding to the first DRX configuration needs to be adjusted to match the wakeup time period corresponding to the resource pool configuration, or a time-domain location of the wakeup time period corresponding to the resource pool configuration needs to be adjusted to match the wakeup time period corresponding to the first DRX configuration. The following uses an example in which the time-domain location of the wakeup time period corresponding to the first DRX configuration is adjusted to match the wakeup time period corresponding to the resource pool configuration for description.

Optionally, the first configuration, for example, the resource pool configuration, corresponds to one or more time-domain adjustment amounts. The one or more time-domain adjustment amounts may be configured/preconfigured/predefined for UE (per UE) or a cell (per cell). Optionally, the terminal device may carry the one or more time-domain adjustment amounts in a link setup message sent by the terminal device. Correspondingly, the determining the second DRX configuration based on the first DRX configuration and/or the first configuration may include: determining the second DRX configuration by adjusting a time-domain location of a wakeup time period corresponding to the first DRX configuration and/or the first configuration based on the one or more time-domain adjustment amounts. A start location and/or an end location of a wakeup time period corresponding to the second DRX configuration are/is within the wakeup time period corresponding to the first configuration.

For example, as shown in FIG. 7, the resource pool configuration includes one time-domain adjustment amount T1, and the wakeup time period corresponding to the first DRX configuration may be shifted forward or backward by T1, to obtain the second DRX configuration. For example, wakeup time periods D1 (start and end moments are t3 and t4) and D2 of the first DRX configuration may be shifted forward by T1 to generate wakeup time periods A1 (start and end moments are t1 and t2, that is, t3−t1=t4−t2=T1) and A2, to obtain a second DRX configuration A. Alternatively, the wakeup time periods D1 and D2 (start and end moments are t5 and t6) of the first DRX configuration may be shifted backward by T1 to wakeup time periods B1 and B2 (start and end moments are t7 and t8, that is, t8−t6=t7−t5=T2), to obtain a second DRX configuration B. Shifting forward may be understood as entering a wakeup time period in advance, and shifting backward may be understood as postponing entering a wakeup time period.

For example, as shown in FIG. 8, the resource pool configuration includes three time-domain adjustment amounts T3, T4, and T5. Any wakeup time period corresponding to the first DRX configuration may be shifted forward or backward by any time-domain adjustment amount, to obtain the second DRX configuration. For example, a wakeup time period D1 (start and end moments are t3 and t4) of the first DRX configuration may be shifted forward by T1 to a wakeup time period C1 (start and end moments are t1 and t2, that is, t3−t1=t4−t2=T1), and a wakeup time period D4 (start and end moments are t5 and t6) of the first DRX configuration may be shifted backward by T4 to a wakeup time period C4 (start and end moments are t7 and t8, that is, t7−t5=t8−t6=T4), a wakeup time period D5 (start and end moments are t10 and t11) of the first DRX configuration is shifted backward by T5 to a wakeup time period C5 (start and end moments are t8 and t9, that is, t10−t8=t11−t9=T5). In addition, because there is an overlapping window between wakeup time periods D2 and D3 and wakeup time periods corresponding to the resource pool configuration, it is considered as matching, and no adjustment is made. In this way, a second DRX configuration C may be finally obtained.

It should be noted that a manner of using the time-domain offset of the resource pool (shifting forward and/or backward) may be preconfigured or predefined in the terminal device, for example, only shifting forward or backward, preferentially shifting forward or backward, or determine, based on a window length of the overlapping window obtained after shifting forward and backward, to actually shift forward or backward. Optionally, when there are a plurality of time-domain offsets, a manner of using the plurality of time-domain offsets, for example, a use priority, may be preconfigured or predefined. When the third terminal device determines that a priority of a MAC PDU is high (for example, higher than and/or equal to a configured or preconfigured threshold, that is, a priority value is less than and/or equal to the configured or preconfigured threshold), the wakeup time period is adjusted to completely match or partially match the first configuration by using the time-domain offset. Alternatively, a value of an actually used time-domain offset, a manner of using the time-domain offset, and the like are determined based on a size of the adjusted overlapping window. The size of the overlapping window may include a value of the window length of the overlapping window, a ratio of the window length of the overlapping window to duration of a wakeup time period corresponding to the resource pool configuration overlapping with the overlapping window, and the like.

In addition, the third terminal device and the fourth terminal device may obtain the second DRX configuration based on the same adjustment rule, and send/receive signaling and/or data based on the second DRX configuration, to further improve a monitoring success rate and communication efficiency.

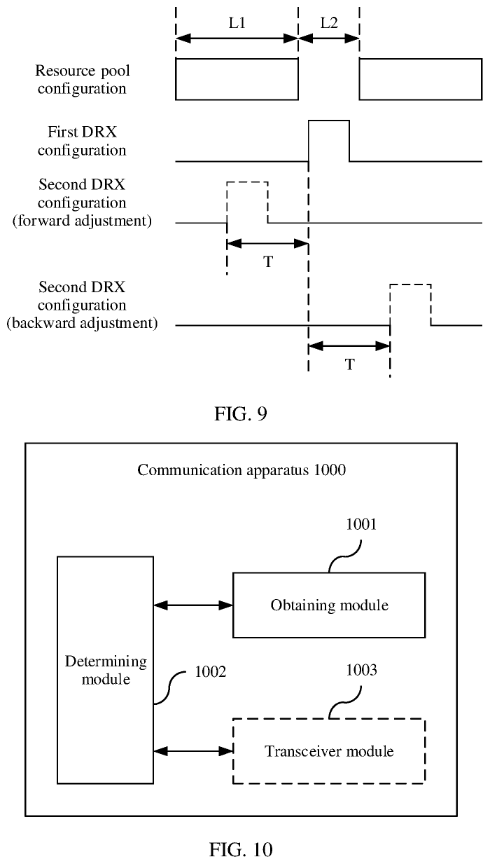

For example, FIG. 9 is an example 3 of a resource pool configuration and a first DRX configuration according to an embodiment of this application. As shown in FIG. 9, one periodicity of the resource pool configuration includes a wakeup time period L1 and a sleep time period L2, and L1>L2. A time-domain offset is T. When L2<T≤L1, forward shifting or backward shifting may be performed based on T, so that a start location or an end location of the adjusted wakeup time period may be within a valid time period corresponding to the resource pool configuration. It should be understood that, in some scenarios, for example, when L1<L2, it may be unable to adjust some wakeup time periods corresponding to the first DRX configuration to wakeup time periods corresponding to the resource pool configuration. In this case, the adjustment may be skipped.

Optionally, the terminal device determines whether the first DRX configuration and the first configuration can have an overlapping window based on the time-domain offset. If the first DRX configuration and the first configuration can completely or partially overlap by adjusting the wakeup time period based on the time-domain offset, it is determined to make the adjustment. Otherwise, a current wakeup time period and/or a wakeup time period that is close in time domain are/is not adjusted; or a DRX monitoring function is disabled (disable).

It should be noted that the example of matching shown in FIG. 6 is described by using the first DRX configuration and the service configuration as an example, and is also applicable to a scenario in which the first DRX configuration matches the resource pool. Similarly, the scenario of mismatching shown in FIG. 7 to FIG. 9 is described by using an example in which the resource pool configuration matches the first DRX configuration, and the second DRX configuration that matches the resource pool configuration is obtained by adjusting the first DRX configuration. In other words, the method for determining matching provided in this application and the method for adjusting the time-domain location of the wakeup time period to obtain the second DRX configuration in the case of mismatching may be applicable to any one of the following scenarios: Scenario 1: It is determined whether the first DRX configuration matches the service configuration. If no, the time-domain location of the first DRX configuration or the service configuration is adjusted. Scenario 2: It is determined whether the first DRX configuration matches the resource pool configuration. If no, the time-domain location of the first DRX configuration or the resource pool configuration is adjusted. For specific implementation, refer to FIG. 6 to FIG. 9. Details are not described herein again.

In addition, when the first DRX configuration mismatches the resource pool configuration, the third terminal device may use a manner of adjusting the resource pool configuration. The adjustment manner may be considered as that the third terminal device selects a resource based on a matching result. It should be understood that the third terminal device may select a resource in the resource pool, a resource outside the resource pool, or a resource from both in and outside the resource pool, for example, select, from all resources that the third terminal device can support, a resource that matches the first DRX configuration. This is not specifically limited in this embodiment of this application.

S503: The third terminal device sends signaling and/or data based on the second DRX configuration. Correspondingly, the fourth terminal device receives the signaling and/or the data based on the second DRX configuration.

In a possible design solution, when the first DRX configuration matches the first configuration, the second DRX configuration is the first DRX configuration. In this case, the third terminal device may send signaling and/or data based on the first DRX configuration. Correspondingly, the fourth terminal device may receive the signaling and/or the data based on the first DRX configuration. The signal and/or the data sent/received based on the first DRX configuration may include a PSCCH and a PSSCH of a detected service and a link setup message of a burst service.

In another possible design solution, when the first DRX configuration mismatches the first configuration, the third terminal device and the fourth terminal device need to negotiate for a second DRX configuration, and send/receive signaling and/or data of a detected service based on the second DRX configuration. Optionally, if the third terminal device and the fourth terminal device fail to negotiate for the second DRX configuration, the DRX function is disabled. Specifically, any one of the following solutions may be used for implementation.

Solution 1: The third terminal device and the fourth terminal device may maintain two DRX configurations: a first DRX configuration and a second DRX configuration. The first DRX configuration is used to publish/monitor a burst service, for example, publish/monitor a link setup message of a burst service or an aperiodic service. The second DRX configuration is used to send/receive a detected service, for example, send/receive a PSCCH and a PSSCH of the detected service. This may specifically include: The third terminal device sends signaling and/or data of a burst service, and/or selects a resource based on the first DRX configuration. For example, the third terminal device receives a message of a first service based on the first DRX configuration, obtains information such as a periodicity, duration, and a traffic pattern (traffic pattern) of the first service, and determines a cycle, wakeup duration, timer duration, and the like of the second DRX configuration to match the first service, and/or selects a periodic resource based on the cycle of the first service. For example, a reserved interval between resources is set as a time interval between two wakeup time periods that are adjacent in time domain and that are of the first service or the first configuration, and signaling and/or data of the detected service is sent based on the second DRX configuration. Correspondingly, the fourth terminal device receives the signaling and/or the data of the burst service based on the first DRX configuration, and receives the signaling and/or the data of the detected service based on the second DRX configuration. The burst service is a service that is newly initiated by the third terminal device and that has not been detected by the fourth terminal device.

Services in embodiments of this application may include new data/signaling/feedback sent on channels of a plurality of types: a physical sidelink feedback channel (physical sidelink feedback channel, PSFCH), a PSSCH and a PSCCH. This is not specifically limited in embodiments of this application.

Solution 2: The third terminal device and the fourth terminal device maintain only one DRX configuration, that is, switch between the first DRX configuration and the second DRX configuration. The first DRX configuration is used to publish/monitor a burst service, and the second DRX configuration is used to send/receive a detected service. This may specifically include: The third terminal device sends a first switching indication based on the first DRX configuration. Correspondingly, the fourth terminal device receives the first switching indication based on the first DRX configuration. The first switching instruction indicates switching from receiving signaling and/or data based on the first DRX configuration to receiving signaling and/or data based on the second DRX configuration.

Then, the third terminal device and the fourth terminal device switch to the second DRX configuration based on the first switching indication, and send/receive signaling and/or data of a detected service based on the second DRX configuration. Optionally, the third terminal device may further publish a burst service based on the second DRX configuration, and the fourth terminal device may also monitor the burst service based on the second DRX configuration.

Then, when completion of the service is detected, for example, the fourth terminal device receives a DRX MAC CE corresponding to the service (for example, a service identifier), the fourth terminal device sends a second switching indication based on the second DRX configuration, and the third terminal device receives the second switching indication based on the second DRX configuration. The second switching indication indicates switching from sending signaling and/or data based on the second DRX configuration back to sending signaling and/or data based on the first DRX configuration.

Based on the communication method shown in FIG. 5, the terminal device determines whether the first configuration matches the first DRX configuration. If the first configuration matches the first DRX configuration, the terminal device sends/receives signaling and/or data based on the first DRX configuration. If the first configuration mismatches the first DRX configuration, the second DRX configuration that matches the first DRX configuration is generated, and the terminal device sends/receives signaling and/or data based on the second DRX configuration. For example, the terminal device sends/receives signaling and/or data in a wakeup time period corresponding to the second DRX configuration, and sleeps in a sleep time period corresponding to the second DRX configuration. In this way, high power consumption caused when the terminal device keeps awake to avoid missing a burst service can be resolved, and low monitoring success rate caused by a difference between a DRX configuration of a terminal device and a DTX configuration of another terminal device can be resolved. This meets requirements of both low power consumption and communication reliability of the terminal device.

Optionally, a correspondence between a DRX configuration and a priority is configured, preconfigured, or predefined for the terminal device. After the third terminal device generates a MAC PDU or after the fourth terminal device receives SCI and/or a MAC PDU, a third DRX configuration and/or another DRX configuration are/is determined based on a priority corresponding to the MAC PDU (for example, the priority may be a highest priority of an LCH multiplexed in the MAC PDU or a priority of a MAC CE). Optionally, the DRX configuration includes one or more priority values. For example, the network device configures that a DRX configuration 1 corresponds to a priority 1, a DRX configuration 2 corresponds to a priority 2, and a DRX 3 corresponds to a priority 3. When the third terminal device generates a MAC PDU, and determines that a priority corresponding to the MAC PDU is 1, it is determined that the third DRX configuration of the third terminal device is the DRX configuration 1. Optionally, the third terminal device provides, in SCI or other signaling (for example, a MAC CE or an RRC message), an indication related to the DRX configuration 1 for the fourth terminal device. After receiving the indication, the fourth terminal device maintains or establishes or configures monitoring based on the DRX configuration 1.

Alternatively, the third terminal device selects, based on a priority of an LCH on which valid data currently exists, a DRX configuration corresponding to the priority value.

Optionally, after generating the MAC PDU by the third terminal device, a process of triggering resource reselection/selection by the third terminal device, determining setup authorization by the third terminal device, determining available data (available data) in an LCH with a higher priority by the third terminal device, and the like may be an alternative. This is not limited.

Optionally, a correspondence between a DRX configuration and a service is configured, preconfigured, or predefined for the terminal device. A higher layer of the third terminal device provides service information (for example, a service identifier and/or a data packet) for an access layer, and the third terminal device searches for a DRX configuration (for example, a wakeup cycle, wakeup duration, or a timer configuration) corresponding to the service information, and determines the found DRX configuration as the third DRX configuration. Optionally, the higher layer of the terminal device provides priority information for the AS layer. After the AS layer receives the indication information, a DRX configuration corresponding to the indication information is determined as the third DRX configuration.

The higher layer (for example, an NAS layer or an RRC layer) of the terminal device indicates a first indication to the access layer (an AS layer, which may be one or more of an SDAP, RRC, a PDCP, an RLC, a MAC and a PHY), and the first indication includes the third DRX configuration.

In addition, optionally, the method in this embodiment may be implemented in combination with a timer in a DRX configuration. For example, if the fourth terminal device detects SCI in a wakeup time period or the third terminal device detects a PSFCH in a wakeup period, an inactivity timer is started or restarted, to prolong wakeup duration of the terminal device.

If the terminal device determines that no time-domain resource exists in a wakeup time period, that is, the moment is outside the overlapping window between the DRX configuration and the first configuration, or there is no overlapping window, the terminal device optionally stops one or more timers. The one or more timers may be:

drx-onDurationTimer: It indicates that the terminal device terminates a wakeup state and enters a sleep state.

drx-InactivityTimer: It indicates that the terminal device terminates a wakeup state and enters a sleep state.

drx-HARQ-RTT-TimerDL/UL: It indicates that the terminal device no longer waits for retransmission and/or scheduling, and/or enters a sleep state. Alternatively, the timer is restarted, and it is considered that no retransmission occurs during running of the timer.

drx-RetransmissionTimer: It indicates that the terminal device no longer waits for retransmission and/or scheduling, and/or enters a sleep state.

drx-ShortCycleTimer: It indicates that the terminal device uses a long DRX cycle.

The foregoing timers may be a timer in a DRX configuration corresponding to a sidelink, or may be a timer corresponding to a Uu DRX configuration.

Optionally, a first identifier is allocated to the terminal device. The first identifier may be a dedicated RNTI, and whether the terminal device sends/receives SCI scrambled by using the first identifier is not controlled by SL-DRX. For example, an SL-D-RNTI is defined, and is specially for monitoring an SL message related to connection establishment, or an SL-B-RNTI is defined, and is specially for monitoring an SL broadcast message (for example, a direct communication request, DCR). UE only needs to monitor/decode SCI scrambled by using a dedicated RNTI.

Whether sidelink signaling/data is a V2P (vehicle-to-pedestrian) message or a V2V (vehicle-to-vehicle) message is distinguished.

TX UE: In the case of a V2V message, it is determined whether a current moment in a wakeup time period corresponding to a first DRX configuration. If yes, sending of the message is delayed until the UE enters a sleep time period corresponding to the first DRX configuration; and the TX UE reserves a resource for the V2V message based on the sleep time period and/or a cycle of the first DRX configuration.

Alternatively, the TX UE still sends the message in the wakeup time period corresponding to the first DRX configuration, and indicates that a message type is V2V or V2P, for example, indicates the message type in SCI or a MAC header.

A DST L1 ID can be used for distinguishing.

If a DST L1 ID and/or a DST L2 ID of V2V conflict/conflicts with a DST L1 ID and/or a DST L2 ID of V2P because the DST L1 ID is short in length, an RNTI corresponding to the V2P message or the V2V message is allocated to the terminal device.

RX UE: Only a V2P message is monitored/decoded in a wakeup time period corresponding to the first DRX configuration. Alternatively, timers such as drx-InactivityTimer and drx-HARQ-RTT-TimerSL are started/restarted only for a V2P message (for example, by using an indication in SCI, a DST L1 ID, or an RNTI).

The communication methods provided in the foregoing embodiments of this application may be separately performed, or may be performed in combination with the foregoing embodiments. A step in which the communication methods are performed is not limited.

For example, the communication methods shown in FIG. 2 and FIG. 5 may be separately performed. For another example, one or more steps in the communication method shown in FIG. 2 and one or more steps in the communication method shown in FIG. 5 may be combined for execution.

The communication methods provided in embodiments of this application are described in detail above with reference to FIG. 3 to FIG. 9. Communication apparatuses provided in embodiments of this application are described in detail below with reference to FIG. 10 to FIG. 12.

For example, FIG. 10 is a schematic diagram 1 depicting a structure of a communication apparatus according to an embodiment of this application.

As shown in FIG. 10, a communication apparatus 1000 includes an obtaining module 1001 and a determining module 1002. For ease of description, FIG. 10 shows only main components of the communication apparatus.

In some embodiments, the communication apparatus 1000 may be applicable to the communication system shown in FIG. 1, and perform a function of the first terminal device in the communication method shown in FIG. 2.

The obtaining module 1001 is configured to obtain first indication information and second indication information. The first indication information indicates a first periodicity for sending signaling and/or data and a second periodicity for not sending signaling and data, and the second indication information indicates a first time unit for sending signaling and/or data and a second time unit for not sending signaling and data in the first periodicity. The determining module 1002 is configured to determine to send signaling and/or data in the first time unit.

In a possible design solution, the first indication information may include L1 indication fields. The L1 indication fields correspond to L1 periodicities, and the L1 periodicities include the first periodicity and the second periodicity.

Similarly, the second indication information may include L2 indication fields. The L2 indication fields correspond to L2 time units included in the first periodicity, and the L2 time units include the first time unit and the second time unit.

Optionally, the first indication information and the second indication information may be implemented in a two-level bit mapping (bitmap) manner.

In this embodiment of this application, a time length of the first periodicity may be greater than or equal to a time length of the L2 continuous time units.

In this embodiment of this application, the periodicity, for example, the first periodicity and the second periodicity, may include a plurality of continuous time units. The time unit included in the first periodicity may be one or more of the following: a system frame (system frame), a direct frame (direct frame), a subframe (subframe), a slot (slot), a short slot (short-slot or mini-slot), and a symbol (symbol).

Optionally, the signaling may be for sidelink (sidelink, SL) communication.

Optionally, the first indication information and the second indication information are associated with a resource pool, and the resource pool includes the first periodicity and the second periodicity in time domain. In this way, the terminal device may monitor signaling and/or data on a resource in the resource pool associated with the first time unit, to implement a communication function.

Optionally, the communication apparatus 1000 may further include a transceiver module 1003. The transceiver module 1003 is configured to implement a sending/receiving function of the communication apparatus 1000, for example, to send signaling and/or data to another communication apparatus, or receive signaling and/or data sent by another communication apparatus. Optionally, the transceiver module 1003 may be a transceiver or an input/output port.

Optionally, modules having a processing function, such as the obtaining module 1001 and the determining module 1002, may also be integrated into one module, for example, a processing module (not shown in FIG. 10). The processing module may be a processor or another component having a processing function.

Optionally, the communication apparatus 1000 may further include a storage module (not shown in FIG. 10). The storage module stores a program or instructions. When the processing module executes the program or the instructions, the communication apparatus 1000 is enabled to perform a function of the second terminal device in the communication method shown in FIG. 2.

It should be noted that the communication apparatus 1000 may be a terminal device, or may be a chip (system) or another part or component that can be disposed in the terminal device. This is not limited in this application.

In addition, for technical effect of the communication apparatus 1000, refer to the technical effect of the communication method shown in FIG. 2. Details are not described herein again.

In some other embodiments, the communication apparatus 1000 may also be applicable to the communication system shown in FIG. 1, and perform a function of the second terminal device in the communication method shown in FIG. 2.

The obtaining module 1001 is configured to obtain first indication information and second indication information. The first indication information indicates a first periodicity for receiving signaling and/or data and a second periodicity for not receiving signaling and data, and the second indication information indicates a first time unit for receiving signaling and/or data and a second time unit for not receiving signaling and data in the first periodicity. The determining module 1002 is configured to determine to receive signaling and/or data in the first time unit.

In a possible design solution, the first indication information may include L1 indication fields. The L1 indication fields correspond to L1 periodicities, and the L1 periodicities include the first periodicity and the second periodicity.

Similarly, the second indication information may include L2 indication fields. The L2 indication fields correspond to L2 time units included in the first periodicity, and the L2 time units include the first time unit and the second time unit.

Optionally, the first indication information and the second indication information may be implemented in a two-level bit mapping (bitmap) manner.

In this embodiment of this application, a time length of the first periodicity may be greater than or equal to a time length of the L2 continuous time units.

In this embodiment of this application, the periodicity, for example, the first periodicity and the second periodicity, may include a plurality of continuous time units. The time unit included in the first periodicity may be one or more of the following: a system frame (system frame), a direct frame (direct frame), a subframe (subframe), a slot (slot), a short slot (short-slot or mini-slot), and a symbol (symbol).

Optionally, the signaling may be for sidelink (sidelink, SL) communication.

Optionally, the first indication information and the second indication information are associated with a resource pool, and the resource pool includes the first periodicity and the second periodicity in time domain. In this way, the terminal device may monitor signaling and/or data on a resource in the resource pool associated with the first time unit, to implement a communication function.

Optionally, the communication apparatus 1000 may further include a transceiver module 1003. The transceiver module 1003 is configured to implement a sending/receiving function of the communication apparatus 1000, for example, to send signaling and/or data to another communication apparatus, or receive signaling and/or data sent by another communication apparatus. Optionally, the transceiver module 1003 may be a transceiver or an input/output port.

Optionally, modules having a processing function, such as the obtaining module 1001 and the determining module 1002, may also be integrated into one module, for example, a processing module (not shown in FIG. 10). The processing module may be a processor or another component having a processing function.

Optionally, the communication apparatus 1000 may further include a storage module (not shown in FIG. 10). The storage module stores a program or instructions. When the processing module executes the program or the instructions, the communication apparatus woo is enabled to perform a function of the first terminal device in the communication method shown in FIG. 2.

It should be noted that the communication apparatus 1000 may be a terminal device, or may be a chip (system) or another part or component that can be disposed in the terminal device. This is not limited in this application.

In addition, for technical effect of the communication apparatus 1000, refer to the technical effect of the communication method shown in FIG. 2. Details are not described herein again.

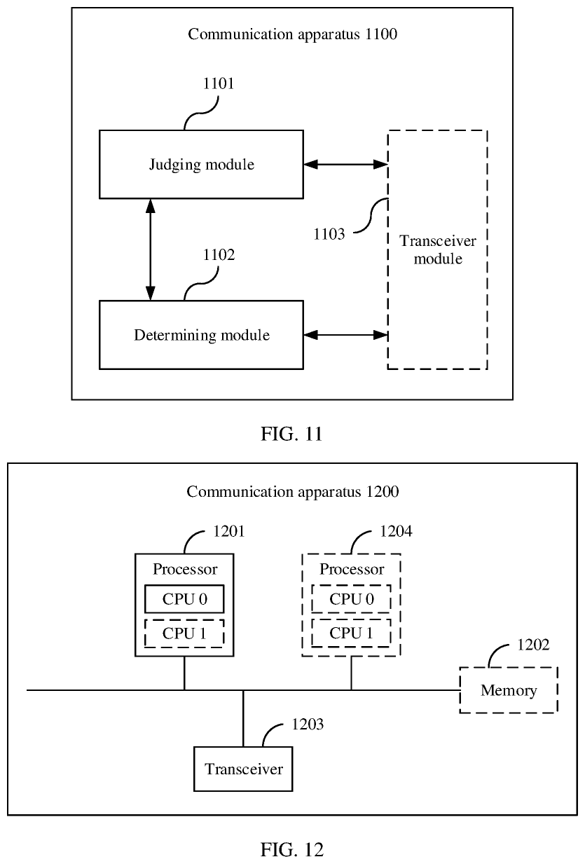

For example, FIG. 11 is a schematic diagram 2 depicting a structure of a communication apparatus 1100 according to an embodiment of this application. As shown in FIG. 11, the communication apparatus 1100 includes a judging module 1101 and a determining module 1102. For ease of description, FIG. 11 shows only main components of the communication apparatus 1100.

In some embodiments, the communication apparatus 1100 may be applicable to the communication system shown in FIG. 1, and perform a function of the third terminal device in the communication method shown in FIG. 5.

The judging module 1101 is configured to determine whether a first configuration matches or mismatches a first DRX configuration. The determining module 1102 is configured to determine, based on a matching result, a second DRX configuration that matches the first configuration, where the second DRX configuration is for sending signaling and/or data.

In a possible design solution, the determining module 1102 is specifically configured to determine the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration.

In another possible design solution, the determining module 1102 is specifically configured to determine the second DRX configuration based on the first DRX configuration and/or the first configuration if the first configuration mismatches the first DRX configuration.

Optionally, the communication apparatus 1100 may further include a transceiver module 1103. The transceiver module 1103 is configured to send signaling and/or data based on the first DRX configuration. The determining module 1102 is further configured to select a resource based on the first DRX configuration.

Optionally, the communication apparatus 1100 may further include a transceiver module 1103. The transceiver module 1103 is configured to send a first switching indication based on the first DRX configuration. The first switching indication indicates switching from sending signaling and/or data based on the first DRX configuration to sending signaling and/or data based on the second DRX configuration.

The transceiver module 1103 is further configured to send a second switching indication based on the second DRX configuration. The second switching indication indicates switching from sending signaling and/or data based on the second DRX configuration back to sending signaling and/or data based on the first DRX configuration.

In a possible design solution, the first configuration corresponds to one or more time-domain adjustment amounts. The determining module 1102 is further configured to determine the second DRX configuration by adjusting a time-domain location of a wakeup time period corresponding to the first DRX configuration and/or the first configuration based on the one or more time-domain adjustment amounts.

Optionally, a start location and/or an end location of a wakeup time period corresponding to the second DRX configuration are/is within the wakeup time period corresponding to the first configuration.

Optionally, the first DRX configuration may be a broadcast-dedicated DRX configuration with a smallest DRX cycle among a plurality of preconfigured or predefined broadcast-dedicated DRX configurations.

Further, the first DRX configuration is for sending signaling and/or data that may be originally sent based on a plurality of broadcast-dedicated DRX configurations.

In a possible design solution, the first configuration may include a service configuration and/or a resource pool configuration.

Optionally, the communication apparatus 1100 may further include a transceiver module 1103. The transceiver module 1103 is configured to implement a sending/receiving function of the communication apparatus 1100, for example, to send signaling and/or data to another communication apparatus 1100, or receive signaling and/or data sent by another communication apparatus 1100. Optionally, the transceiver module 1103 may be a transceiver or an input/output port.

Optionally, modules having a processing function, such as the judging module 1101 and the determining module 1102, may also be integrated into one module, for example, a processing module (not shown in FIG. 11). The processing module may be a processor or another component having a processing function.

Optionally, the communication apparatus 1100 may further include a storage module (not shown in FIG. 11). The storage module stores a program or instructions. When the processing module executes the program or the instructions, the communication apparatus 1100 is enabled to perform a function of the fourth terminal device in the communication method shown in FIG. 5.

It should be noted that the communication apparatus 1100 may be a terminal device, or may be a chip (system) or another part or component that can be disposed in the terminal device. This is not limited in this application.

In addition, for technical effect of the communication apparatus 1100, refer to the technical effect of the communication method shown in FIG. 5. Details are not described herein again.

In some other embodiments, the communication apparatus 1100 may be applicable to the communication system shown in FIG. 1, and perform a function of the fourth terminal device in the communication method shown in FIG. 5.

The judging module 1101 is configured to determine whether a first configuration matches or mismatches a first DRX configuration. The determining module 1102 is configured to determine, based on a matching result, a second DRX configuration that matches the first configuration, where the second DRX configuration is for receiving signaling and/or data.

In a possible design solution, the determining module 1102 is specifically configured to determine the first DRX configuration as the second DRX configuration if the first configuration matches the first DRX configuration.

Optionally, that the first configuration matches the first DRX configuration may include: A DRX cycle of the first DRX configuration corresponds to a service cycle corresponding to the first configuration.

In another possible design solution, the determining module 1102 is specifically configured to determine the second DRX configuration based on the first DRX configuration and/or the first configuration if the first configuration mismatches the first DRX configuration.

Optionally, the communication apparatus 1100 may further include a transceiver module 1103. The transceiver module 1103 is configured to receive signaling and/or data based on the first DRX configuration.

Optionally, the communication apparatus 1100 may further include a transceiver module 1103. The transceiver module 1103 is configured to receive a first switching indication based on the first DRX configuration. The first switching indication indicates switching from receiving signaling and/or data based on the first DRX configuration to receiving signaling and/or data based on the second DRX configuration.

The transceiver module 1103 is further configured to receive a second switching indication based on the second DRX configuration. The second switching indication indicates switching from receiving signaling and/or data based on the second DRX configuration back to receiving signaling and/or data based on the first DRX configuration.

In a possible design solution, the first configuration corresponds to one or more time-domain adjustment amounts. The determining module 1102 is further configured to determine the second DRX configuration by adjusting a time-domain location of a wakeup time period corresponding to the first DRX configuration and/or the first configuration based on the one or more time-domain adjustment amounts.

Optionally, a start location and/or an end location of a wakeup time period corresponding to the second DRX configuration are/is within the wakeup time period corresponding to the first configuration.

Optionally, the first DRX configuration may be a broadcast-dedicated DRX configuration with a smallest DRX cycle among a plurality of preconfigured or predefined broadcast-dedicated DRX configurations.

Further, the first DRX configuration is for receiving signaling and/or data that is originally configured to be received based on a plurality of broadcast-dedicated DRX configurations.

In a possible design solution, the first configuration may include a service configuration and/or a resource pool configuration.

Optionally, the communication apparatus 1100 may further include a transceiver module 1103. The transceiver module 1103 is configured to implement a sending/receiving function of the communication apparatus 1100, for example, to send signaling and/or data to another communication apparatus 1100, or receive signaling and/or data sent by another communication apparatus 1100. Optionally, the transceiver module 1103 may be a transceiver or an input/output port.

Optionally, modules having a processing function, such as the judging module 1101 and the determining module 1102, may also be integrated into one module, for example, a processing module (not shown in FIG. 11). The processing module may be a processor or another component having a processing function.

Optionally, the communication apparatus 1100 may further include a storage module (not shown in FIG. 11). The storage module stores a program or instructions. When the processing module executes the program or the instructions, the communication apparatus 1100 is enabled to perform the communication method shown in FIG. 5.

It should be noted that the communication apparatus 1100 may be a terminal device, or may be a chip (system) or another part or component that can be disposed in the terminal device. This is not limited in this application.

In addition, for technical effect of the communication apparatus 1100, refer to the technical effect of the communication method shown in FIG. 5. Details are not described herein again.

For example, FIG. 12 is a schematic diagram depicting a structure of a communication apparatus 1200 that can be configured to perform the communication method according to an embodiment of this application. The communication apparatus 1200 may be a terminal device, a chip used in the terminal device, or another component having a function of the terminal. As shown in FIG. 12, the communication apparatus 1200 may include a processor 1201, a memory 1202, and a transceiver 1203. The processor 1201 is coupled to the memory 1202 and the transceiver 1203, for example, through a communication bus.

The following describes each component of the communication apparatus 1200 in detail with reference to FIG. 12.

The processor 1201 is a control center of the communication apparatus 1200, and may be one processor or may be a collective term of a plurality of processing elements. For example, the processor 1201 may be one or more central processing units (central processing unit, CPU), may be an application-specific integrated circuit (application specific integrated circuit, ASIC), or may be configured as one or more integrated circuits implementing embodiments of this application, for example, one or more microprocessors (digital signal processor, DSP) or one or more field programmable gate arrays (field programmable gate array, FPGA).

The processor 1201 may perform various functions of the communication apparatus 1200 by running or executing a software program stored in the memory 1202 and invoking data stored in the memory 1202.

During specific implementation, in an embodiment, the processor 1201 may include one or more CPUs, for example, a CPU 0 and a CPU 1 in FIG. 12.

During specific implementation, in an embodiment, the communication apparatus 1200 may also include a plurality of processors, for example, the processor 1201 and a processor 1204 shown in FIG. 12. Each of the processors may be a single-core processor (single-CPU) or may be a multi-core processor (multi-CPU). The processor herein may be one or more communication devices, circuits, and/or processing cores configured to process data (for example, computer program instructions).

The memory 1202 may be a read-only memory (read-only memory, ROM) or another type of static storage communication device that can store static information and instructions, a random access memory (random access memory, RAM) or another type of dynamic storage communication device that can store information and instructions, an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic disk storage medium or another magnetic storage communication device, or any other medium that can be used for carrying or storing expected program code in a form of an instruction or a data structure and that can be accessed by a computer. However, the memory 1202 is not limited thereto. The memory 1202 may be integrated with the processor 1201, or may exist independently, and is coupled to the processor 1201 through an input/output port (not shown in FIG. 12) of the communication apparatus 1200. This is not specifically limited in this embodiment of this application.

The memory 1202 is configured to store a software program for implementing solutions of this application, and the processor 1201 controls the implementation. For a specific implementation, refer to the following method embodiments. Details are not described herein.

The transceiver 1203 is configured for communication with another communication apparatus. For example, the communication apparatus 1200 is a terminal device, and the transceiver 1203 may be configured to communicate with a network device or communicate with another terminal device. For another example, the communication apparatus 1200 is a network device, and the transceiver 1203 may be configured to communicate with a terminal device or communicate with another network device. In addition, the transceiver 1203 may include a receiver and a transmitter (not separately shown in FIG. 12). The receiver is configured to implement a receiving function, and the transmitter is configured to implement a sending function. The transceiver 1203 may be integrated with the processor 1201, or may exist independently, and is coupled to the processor 1201 through an input/output port (not shown in FIG. 12) of the communication apparatus 1200. This is not specifically limited in this embodiment of this application.

It should be noted that the structure of the communication apparatus 1200 shown in FIG. 12 does not constitute a limitation on the communication apparatus. An actual communication apparatus may include more or fewer components than those shown in the figure, or combine some components, or have different component arrangements.

An embodiment of this application provides a communication system. The communication system includes a plurality of terminal devices. Optionally, the communication system may further include one or more network devices.

It should be understood that, the processor in embodiments of this application may be a central processing unit (central processing unit, CPU), or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, a discrete hardware component, or the like. The general-purpose processor may be a microprocessor, any conventional processor, or the like.

It may be understood that the memory in embodiments of this application may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. By way of example but not limitative description, random access memories (random access memory, RAM) in many forms may be used, for example, a static random access memory (static RAM, SRAM), a dynamic random access memory (dynamic random access memory, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

All or a part of the foregoing embodiments may be implemented by using software, hardware (for example, circuit), firmware, or any combination thereof. When software is used to implement the embodiments, the foregoing embodiments may be implemented completely or partially in a form of a computer program product. The computer program product includes one or more computer instructions or computer programs. When the program instructions or the computer programs are loaded and executed on a computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, and microwave, or the like) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and indicates that three relationships may exist. For example, A and/or B may indicate the following three cases: only A exists, both A and B exist, and only B exists. A and B may be singular or plural. In addition, the character “/” in this specification usually indicates an “or” relationship between the associated objects, or may indicate an “and/or” relationship. A specific meaning depends on a context.

In this application, “at least one” means one or more, and “a plurality of” means two or more. “At least one of the following items (pieces)” or a similar expression thereof refers to any combination of these items, including any combination of singular items (pieces) or plural items (pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with units and algorithm steps in the examples described in embodiments disclosed in this specification, this application can be implemented by electronic hardware or a combination of computer software and electronic hardware. Whether the functions are implemented by hardware or software depends on particular applications and design constraint conditions of the technical solutions. A person skilled in the art may use different methods to implement the described functions for each particular application, but it should not be considered that the implementation goes beyond the scope of this application.

A person skilled in the art may clearly understand that, for the purpose of convenient and brief description, for detailed working processes of the foregoing system, apparatus, and unit, refer to corresponding processes in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division in actual implementation. For example, a plurality of units or components may be combined or integrated into another system, or some features may be ignored or not performed. In addition, the displayed or discussed mutual coupling or direct coupling or communication connection may be implemented through some interfaces. The indirect coupling or communication connection between the apparatuses or units may be implemented in electrical, mechanical, or other forms.

The units described as separate parts may or may not be physically separate, and parts displayed as units may or may not be physical units, to be specific, may be located in one position, or may be distributed on a plurality of network units. A part or all of the units may be selected according to actual requirements to achieve the objectives of the solutions of the embodiments.

In addition, functional units in embodiments of this application may be integrated into one processing unit, or each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or a part of the technical solutions may be implemented in a form of a software product. The computer software product is stored in a storage medium, and includes several instructions for instructing a computer device (which may be a personal computer, a server, a network device, or the like) to perform all or a part of the steps of the methods described in embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method, performed by a terminal device, or, a chip for the terminal device, the method comprising:
receiving, from a network device, at least one correspondence, wherein each correspondence of the at least one correspondence is between a respective discontinuous reception (DRX) configuration and a respective service, and each respective service is a multicast service or a broadcast service for a side link (SL) communication; and
receiving, from another terminal device, data of a first service according to a first DRX configuration, wherein the first DRX configuration is determined based on a correspondence between the first service and the first DRX configuration, and the correspondence between the first service and the first DRX configuration is comprised in the at least one correspondence.

2. The method according to claim 1, wherein each DRX configuration of the at least one correspondence comprises one or more of the following:
a wakeup cycle, wakeup duration, or a timer configuration.

3. The method according to claim 1, wherein information about each service of the at least one correspondence comprises one or more of the following:
a service identifier, or, a data packet.

4. A method, performed by a network device, or a chip for the network device, the method comprising:
sending at least one correspondence, wherein each correspondence of the at least one correspondence is between a respective discontinuous reception (DRX) configuration and a respective service, each respective service being a multicast service or a broadcast service for a side link (SL) communication; and
wherein the at least one correspondence comprises a first correspondence between a first DRX configuration and a first service, and the first DRX configuration is used for the SL communication of the first service.

5. The method according to claim 1, wherein each DRX configuration of the at least one correspondence comprises one or more of the following:
a wakeup cycle, wakeup duration, or a timer configuration.

6. The method according to claim 1, wherein information about each service of the at least one correspondence comprises one or more of the following:
a service identifier, or, a data packet.

7. An apparatus, comprising a processor, coupled with a memory, wherein the processor is configured to execute a computer program stored in the memory, to cause the apparatus perform the following:
receiving, from a network device, at least one correspondence, wherein each correspondence of the at least one correspondence is between a respective discontinuous reception (DRX) configuration and a respective service, each respective service being a multicast service or a broadcast service for a side link (SL) communication; and
receiving, from another terminal device, data of a first service according to a first DRX configuration, wherein the first DRX configuration is determined based on a first correspondence between the first service and the first DRX configuration, and the at least one correspondence comprises the first correspondence between the first DRX configuration and the first service.

8. The apparatus according to claim 7, wherein each DRX configuration of the at least one correspondence comprises one or more of the following:
a wakeup cycle, wakeup duration, or a timer configuration.

9. The apparatus according to claim 8, wherein information about each service of the correspondence comprises one or more of the following:
a service identifier, or, a data packet.

10. An apparatus, comprising a processor, coupled with a memory, wherein the processor is configured to execute a computer program stored in the memory, to cause the apparatus perform the following:
sending at least one correspondence, wherein each correspondence of the at least one correspondence is between a respective discontinuous reception (DRX) configuration and a respective service, each respective service being a multicast service or a broadcast service for a side link (SL) communication; and
wherein the at least one correspondence comprises a first correspondence between a first DRX configuration and a first service, and the first DRX configuration is used for the SL communication of the first service.

11. The apparatus according to claim 10, wherein each DRX configuration of the at least one correspondence comprises one or more of the following:
a wakeup cycle, wakeup duration, or a timer configuration.

12. The apparatus according to claim 10, wherein information about each service of the at least one correspondence comprises one or more of the following:
a service identifier, or, a data packet.
